(19) United States
(12) Patent Application Publication
(10) Pub. No.: US 2016/0380886 A1
(43) Pub. Date: Dec. 29, 2016

(54) DISTRIBUTED DATA CENTER ARCHITECTURE

(71) Applicant: Ciena Corporation, Hanover, MD (US)

(72) Inventors: Loudon T. BLAIR, Severna Park, MD (US); Joseph BERTHOLD, Whitehouse Station, NJ (US); Nigel L. BRAGG, Weston Colville (UK); Raghuraman RANGANATHAN, Bellaire, TX (US)

(21) Appl. No.: 14/750,129

(22) Filed: Jun. 25, 2015

(51) Int. Cl. H04L 12/723; H04Q 11/00; H04J 14/02; H04L 29/08

(52) U.S. Cl. CPC H04L 45/50; H04L 67/10; H04Q 11/0066; H04J 14/0212; H04Q 2011/0016; H04Q 2011/0077

(57) ABSTRACT

A network element is configured to provide a distributed data center architecture between at least two data center locations. The network element includes a plurality of ports configured to switch packets between one another; wherein a first port of the plurality of ports is connected to an intra-data center network of a first data center location and a second port of the plurality of ports is connected to a second data center location that is remote from the first data center location over a Wide Area Network (WAN), and wherein the intra-data center network of the first data center location, the WAN, and an intra-data center network of the second data center location utilize an ordered label structure between one another to form the distributed data center architecture.

### FIELD OF THE DISCLOSURE

The present disclosure generally relates to networking systems and methods. More particularly, the present disclosure relates to systems and methods for a distributed data center architecture.

### BACKGROUND OF THE DISCLOSURE

The integration of Wide Area Networks (WANs) and data center networks is an evolving trend for network operators who have traditional network resources, Network Functions Virtualization Infrastructure (NFVI), and/or new data center facilities. Conventional intra-data center network connectivity predominantly uses packet switching devices (such as Ethernet switches and Internet Protocol (IP) routers) in a distributed arrangement (e.g., using a fat tree or leaf/spine topology based on a folded Clos switch architecture) to provide a modular, scalable, and statistically non-blocking switching fabric that acts as an underlay network for overlaid Ethernet networking domains. Interconnection between Virtual Machines (VMs) is typically based on the use of overlay networking approaches, such as Virtual Extensible Local Area Network (VXLAN) running on top of an IP underlay network. Data Center Interconnection (DCI) between VMs located in a different data center may be supported across a routed IP network or an Ethernet network. Connectivity to a data center typically occurs through a Data Center Gateway (GW). Conventionally, gateways are inevitably “IP routed” devices. Inside the data center, packets are forwarded through tunnels in the underlay network (e.g., by Border Gateway Protocol (BGP) or Software Defined Networking (SDN)), meaning that connectivity is built using routers and their IP loopback address and adjacencies. The GW might peer at the control plane level with a WAN network, which requires knowledge of its topology, including the remote sites. This uses either a routing protocol or SDN techniques to distribute reachability information.

Conventionally, data center fabrics are typically designed to operate within a single facility. Communication to and from each data center is typically performed across an external network that is independent of the data center switching fabric. This imposes scalability challenges when the data center facility has maximized its space and power footprint. When a data center is full, a data center operator who wants to add to their existing server capacity, must grow this capacity in a different facility and communicate with their resources as if they are separate and independent. A Data Center Interconnect (DCI) network is typically built as an IP routed network, with associated high cost and complexity. Traffic between servers located in a data center is referred to as Eas-West traffic. A folded Clos switch fabric allows any server to communicate directly with any other server by connecting from a Top of Rack switch (TOR)—a Leaf node—up to the Spine of the tree and back down again. This creates a large volume of traffic up and down the switching hierarchy, imposing scaling concerns.

New data centers that are performing exchange functions between users and applications are increasingly moving to the edge of the network core. These new data centers are typically smaller than those located in remote areas, due to limitations such as the availability of space and power within city limits. As these smaller facilities fill up, many additional users are unable to co-locate to take advantage of the exchange services. The ability to tether multiple small data center facilities located in small markets to a larger data center facility in a large market provides improved user accessibility. Increasingly, access service providers want to take advantage of Network Functions Virtualization (NFV) to replace physical network appliances. Today, data centers and access networks are operated separately as different operational domains. There are potential Capital Expenditure (CapEx) and Operational Expenditure (OpEx) benefits to operating the user to content access network and the data center facilities as a single operational entity, i.e., the data centers with the access networks.

New mobility solutions such as Long Term Evolution (LTE) and 5th Generation mobile are growing in bandwidth and application diversity. Many new mobile applications such as machine-to-machine communications (e.g., for Internet of Things (IoT)) or video distribution or mobile gaming demand ultra-short latency requirements between the mobile user and computer resources associated with different applications. Today's centralized computer resources are not able to support many of the anticipated mobile application requirements without placing computer functions closer to the user. Additionally, cloud services are changing how networks are designed. Traditional network operators are adding data center functions to switching central offices and the like.

### BRIEF SUMMARY OF THE DISCLOSURE

In an exemplary embodiment, a network element configured to provide a single distributed data center architecture between at least two data center locations, the network element includes a plurality of ports configured to switch packets between one another; wherein a first port of the plurality of ports is connected to an intra-data center network of a first data center location and a second port of the plurality of ports is connected to a second data center location that is remote from the first data center location over a Wide Area Network (WAN), and wherein the intra-data center network of the first data center location, the WAN, and an intra-data center network of the second data center location utilize a ordered label structure between one another to form the single distributed data center architecture. The ordered label structure can be a unified label space between the intra-data center network of the first data center location, the WAN, and the intra-data center network of at least the second data center location. The ordered label structure can be a unified label space between the intra-data center network of the first data center location and the intra-data center network of the second data center location, and tunnels in the WAN connecting the intra-data center network of the first data center location and the intra-data center network of at least the second data center location.

The distributed data center architecture can only use Multiprotocol Label Switching (MPLS) in the intra geographically distributed data center WAN with Internet Protocol (IP) routing at edges of the distributed data center architecture. The ordered label structure can utilize Multiprotocol Label Switching (MPLS) with Hierarchical Software Defined Networking (HSDN). The ordered label structure can further utilize Segment Routing in an underlay network in the WAN. The ordered label structure can be a rigid switch hierarchy between the intra-data center network of the first data center location, the WAN, and the intra-data center network of at least the second data center location. The ordered label structure can be an unmatched switch hierarchy between the intra-data center network of the first data center location, the WAN, and at least the intra-data center network of the second data center location. The ordered label structure can be a matched switch hierarchy with logically matched waypoints between the intra-data center network of the first data center location, the WAN, and at least the intra-data center network of the second data center location.

The network element can further include a packet switch communicatively coupled to the plurality of ports and configured to perform Multiprotocol Label Switching (MPLS) per Hierarchical Software Defined Networking (HSDN) using the ordered label structure; and a media adapter function configured to create a Wavelength Division Multiplexing (WDM) signal for the second port over the WAN. A first device in the first data center location can be configured to communicate with a second device in the second data center location using the ordered label structure to perform Multiprotocol Label Switching (MPLS) per Hierarchical Software Defined Networking (HSDN), without using Internet Protocol (IP) routing between the first device and the second device.

In another exemplary embodiment, an underlay network formed by one or more network elements and configured to provide a geographically distributed data center architecture between at least two data center locations includes a first plurality of network elements communicatively coupled to one another forming a data center underlay; and a second plurality of network elements communicatively coupled to one another forming a Wide Area Network (WAN) underlay, wherein at least one network element of the first plurality of network elements is connected to at least one network element of the second plurality of network elements, wherein the data center underlay and the WAN underlay utilize a ordered label structure between one another to define paths through the distributed data center architecture.

The ordered label structure can include a unified label space between the data center underlay and the WAN underlay, such that the data center underlay and the WAN underlay form a unified label domain under a single administration. The ordered label structure can include a unified label space between the at least two data center locations connected by the data center underlay, and tunnels in the WAN underlay connecting the at least two data center locations, such that the data center underlay and the WAN underlay form separately-administered label domains. The distributed data center architecture can only use Multiprotocol Label Switching (MPLS) in the WAN with Internet Protocol (IP) routing at edges of a label domain for the distributed data center architecture. The ordered label structure can utilize Multiprotocol Label Switching (MPLS) with Hierarchical Software Defined Networking (HSDN).

The ordered label structure can be a rigid switch hierarchy between the data center underlay and the WAN underlay. The ordered label structure can be an unmatched switch hierarchy between the data center underlay and the WAN underlay. At least one of the network elements in the first plurality of network elements and the second plurality of network elements can include a packet switch communicatively coupled to a plurality of ports and configured to perform Multiprotocol Label Switching (MPLS) per Hierarchical Software Defined Networking (HSDN) using the ordered label structure, and a media adapter function configured to create a Wavelength Division Multiplexing (WDM) signal for a second port over the WAN.

In a further exemplary embodiment, a method performed by a network element to provide a distributed data center architecture between at least two data centers includes receiving a packet on a first port connected to an intra-data center network of a first data center, wherein the packet is destined for a device in an intra-data center network of a second data center, wherein the first data center and the second data center are geographically diverse and connected over a Wide Area Network (WAN) in the distributed data center architecture; and transmitting the packet on a second port connected to the WAN with a label stack thereon using a ordered label structure to reach the device in the second data center.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a user-content network;

FIG. 2 is a network diagram of a comparison of a hierarchical topological structure of the user-to-content network and an intra-data center network;

FIGS. 3A and 3B are network diagrams of conventional separate data centers (FIG. 3A) and a distributed data center (FIG. 3B) using the distributed data center architecture

FIGS. 4A and 4B are hierarchical diagrams of an ordered, reusable label structure (e.g., Hierarchical Software Defined Networking (HSDN)) for an underlay network utilized for connectivity between the data centers in the distributed data center of FIG. 3B;

FIG. 5 is a network diagram of the intra-data center network with a structured folded Clos tree, abstracted to show an ordered, reusable label structure (e.g., HSDN);

FIG. 6 is a network diagram of a network showing the structured folded Clos tree with a generalized multi-level hierarchy of switching domains for a distributed data center;

FIGS. 7A, 7B, and 7C are logical network diagrams illustrates connectivity in the network with an ordered, reusable label structure (e.g., HSDN) (FIG. 7A) along with exemplary connections (FIGS. 7B and 7C);

FIG. 8 is a logical diagram of a 3D Folded Clos Arrangement with geographically distributed edge ‘rack’ switches;

FIGS. 9A and 9B are network diagrams of networks for distributed VM connectivity;

FIGS. 10A and 10B are network diagrams of the networks of FIGS. 9A and 9B using an ordered, reusable label structure (e.g., HSDN) for WAN extension;

FIG. 11 is a network diagram of a distributed data center between a macro data center and a micro data center illustrating a common DC/WAN underlay with a rigid matched switch hierarchy;

FIG. 12 is a network diagram of a distributed data center between a macro data center and two micro data centers illustrating a common DC/WAN underlay with a WAN hairpin;

FIG. 13 is a network diagram of a distributed data center between a macro data center and a micro data center illustrating a common DC/WAN underlay with an unmatched switch hierarchy;

FIG. 14 is a network diagram of a distributed data center between a macro data center and a micro data center illustrating separate DC and WAN underlays for a single distributed data center;

FIG. 15 is a network diagram of a distributed data center between macro data centers and a micro data center illustrating separate DC and WAN underlays for dual macro data centers;

FIG. 16 is a network diagram of a distributed data center between a macro data center and a micro data center illustrating separate DC and WAN underlays for a dual macro data center, where the path to macro data center A passes through two WANs;

FIG. 17 is a network diagram of a distributed data center between a macro data center and a micro data center illustrating a hybrid common and different data center and WAN identifier space;

FIGS. 18A and 18B are network diagrams of options for SDN control and orchestration between the user-content network and the data center network;

FIG. 19 is a network diagram of a network showing integrated use of an ordered, reusable label stack (e.g., HSDN) across the WAN and the distributed data center;

FIGS. 20A and 20B are network diagrams of the network of FIG. 19 showing the physical location of IP functions (FIG. 20A) and logical IP connectivity (FIG. 20B);

FIG. 21 is a network diagram illustrates the network with an asymmetric, ordered, reusable label structure (e.g., HSDN);

FIGS. 22A and 22B are network diagrams illustrate physical implementations of a network element for a WAN switch interfacing between the data center and the WAN;

FIG. 23 is a block diagram of an exemplary implementation of a switch for enabling the distributed data center architecture; and

FIG. 24 is a block diagram of an exemplary implementation of a network element for enabling the distributed data center architecture.

### DETAILED DESCRIPTION OF THE DISCLOSURE

In various exemplary embodiments, systems and methods are described for a distributed data center architecture. Specifically, the systems and methods describe a distributed connection and computer platform with integrated data center (DC) and WAN network connectivity. The systems and methods enable a data center underlay interconnection of users and/or geographically distributed computer servers/Virtual Machines (VMs) or any other unit of computing, where servers/VMs are located (i) in data centers and/or (ii) network elements at (a) user sites and/or (b) in the WAN. All servers/VMs participate within the same geographically distributed data center fabric. Note, as described herein, servers/VMs are referenced as computing units in the distributed data center architecture, but those of ordinary skill in the art will recognize the present disclosure contemplates any type of resource in the data center. The definitions of underlay and overlay networks are described in IETF RFC7365, “Framework for Data Center (DC) Network Virtualization” (10/2014), the contents of which are incorporated by reference.

The distributed data center architecture described here requires no intermediate IP routing in a WAN interconnection network. Rather, the distributed data center architecture uses only an ordered, reusable label structure such as Multiprotocol Label Switching (MPLS) with Hierarchical Software Defined Networking (HSDN) control, for example. For the remainder of this document, HSDN is used as a convenient networking approach to describe the ordered, reusable label structure but other techniques may be considered. Thus, IP routers are not needed because distributed virtual machines are all part of a single Clos switch fabric. Also, because all devices (e.g., switches, virtual switches (vSwitches), servers, etc.) are part of a same HSDN label space, a server can stack labels to pass through the hierarchy to reach destination within a remote DC location without needing to pass through a traditional IP Gateway. The common HSDN addressing scheme simplifies the operation of connecting any pair of virtual machines without complex mappings/de-mapping and without the use of costly IP routing techniques. Further, when using HSDN and Segment Routing (SR) in the same solution, the compatibility between WAN and DC switching technologies simplifies forwarding behavior.

In the context of the topological structure of a user-to-content network, a hierarchical tree of connectivity is formed between users located at customer premises, local Central Offices (COs), Aggregation COs and Hub COs. In many networks, this topological hierarchy may be regarded as equivalent to the rigid hierarchy typically imposed within a data center. Imposing such a structure on a metro network allows simplifications (i.e., the application of HSDN and WAN extensions) to the metro WAN enabling high levels of east-west scaling and simplified forwarding. In this manner and through other aspects described herein, the distributed data center architecture is simpler and lower cost than conventional techniques.

Advantageously, the distributed data center architecture groups VMs/servers into equivalent server pods that could be logically operated as part of one data center fabric, i.e., managed as a seamless part of the same Clos fabric. The distributed data center architecture uses a hierarchical label based connectivity approach for association of VMs/servers distributed in the WAN and in the data center for a single operational domain with unified label space (e.g., HSDN). The distributed data center architecture utilizes a combination of packet switching and optical transmission functions to enable WAN extension with the data center. For example, a packet switching function performs simple aggregation and MPLS label switching (per HSDN), and an optical transmission function performs the high capacity transport. The distributed data center architecture also includes a media adapter function where intra-data center quality optical signals that are optimized for short (few km) distances are converted to inter-data center quality optical signals that are optimized for long (100's to 1,000's km) distances.

For the use of HSDN labels in the WAN, it is important to note the distinction between ‘overlay/underlay tunneling’ and ‘unification of label spaces’. In an IETF draft, draft-fang-mpls-hsdn-for-hsdc-00 entitled “MPLS-Based Hierarchical SDN for Hyper-Scale DC/Cloud” (10/2014), the contents of which are incorporated by reference, HSDN is described as, “ . . . an architectural solution to scale the Data Center (DC) and Data Center Interconnect (DCI) networks”. The draft discusses the data center interconnect (DCI) as a possible layer of the HSDN label stack. The DCI is envisaged as a distinct top layer (Layer 0) of the HSDN architecture used to interconnect all data center facilities in a statistically non-blocking manner. For example, the draft states, “a possible design choice for the UP1s is to have each UP1 correspond to a data center. With this choice, the UP1 corresponds to the DCI and the UPBN1s are the DCGWs in each DC”. The association of “UP0” with “DCI” implies the running of multiple data centers with an integrated identifier space. This concept of overlay tunneling is different from the concept of unification of identifier spaces between WAN and DC in the distributed data center architecture described herein.

### User-Content Network

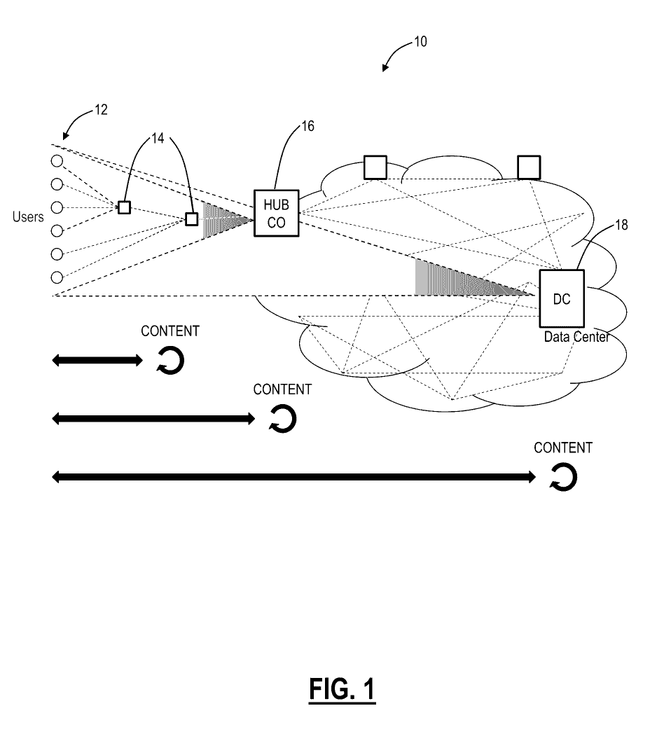

Referring to FIG. 1, in an exemplary embodiment, a network diagram illustrates a user-content network 10. Traditional central offices (COs) will evolve into specialized data centers, and, as described herein, COs 14, 16 are a type of data center. The user-content network 10 includes users 12 with associated services through the user-content network 10 that are fulfilled at local or aggregation COs 14, hub COs 16 and remote data centers 18. As is illustrated in FIG. 1, the user-content network 10 is a hierarchical funnel. Users 12 connect to the hub CO 16 across a network service provider's access and aggregation network, such as via one or more local or aggregation COs 14. Users 12 may also connect to the data centers 18 across the Internet or dedicated private networks. For example, some enterprise users 12 can connect to hosted facilities using Virtual Private Network (VPN), Ethernet private lines, etc. In the case where user services are fulfilled in the hub CO 16, typically a single service provider carries the user traffic to the hub CO 16. Inside the hub CO 16, traffic is distributed locally to servers across an intra-data center network. In the case where services are fulfilled in a remote data center 18, one or more network service providers may carry the user traffic to the data center 18, where it will be terminated in a carrier point-of-presence or meet-me-room within the data center 18. If the data center operator is different from the network service provider, a clear point of demarcation exists at this location between network service provider and data center operator. Beyond this point, traffic is distributed via optical patches or cross-connected locally to an intra-data center network.

There are various direct data center interconnection use cases, associated with the distributed data center architecture. Multiple data centers in a clustered arrangement can be connected. As demands grow over time, data center space and power resources will be consumed, and additional resources will need to be added to the data center fabric. Data centers located in small markets can be tethered to larger data center facilities. As demand for distributed application peering grows, a hierarchy of data center facilities will emerge, with smaller data center facilities located in smaller, (e.g., Tier 3 markets) connecting back to larger data center facilities in Tier 2 and Tier 1 markets.

Network Functions Virtualization (NFV) is promoting the use of Virtual Network Functions (VNFs), which can be located in the aggregation COs 14, hub COs 16, data centers 18, or hosted at locations other than the aggregation COs 14, hub COs 16 or data centers 18 such as at a cell site, an enterprise, and/or residential site. A WAN operator, if different from the data center operator, could also provide a Network Functions Virtualization Infrastructure (NFVI) to the data center operator and thus there is a need to combine such NFVI components as part of the data center fabric. One approach is to treat the VNF locations as micro data centers and to use a traditional Data Center Interconnect (DCI) to interconnect different VMs that are distributed around the WAN. This approach allows interconnection of the remote VMs and the VMs in the data center in a common virtual network, where the VMs might be on the same IP/n subnet. However, with this approach, the servers hosting the VMs are typically treated as independent from the parent DC domain.

Remote servers may be located in network central offices, remote cabinets or user premises and then connected to larger data center facilities. Computer applications can be distributed close to the end users by hosting them on such remote servers. A central office, remote cabinet or user premise may host residential, enterprise or mobile applications in close proximity to other edge switching equipment so as to enable low latency applications. The aggregation function provided by the WAN interface is typically located in the central office. A user can be connected directly to data center facilities. In this example, the WAN interface in the data center provides dedicated connectivity to a single private user's data center. The aggregation function provided by the WAN interface is located in the Central Office, remote cabinet, or end user's location.

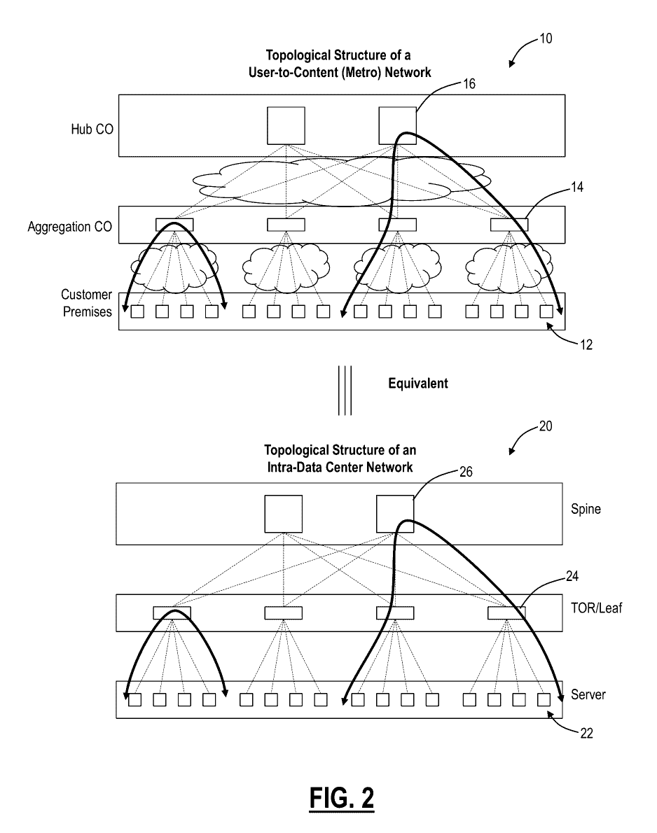

Referring to FIG. 2, in an exemplary embodiment, a network diagram illustrates a comparison of a hierarchical topological structure of the user-to-content network 10 and an intra-data center network 20. FIG. 2 illustrates a hierarchical equivalency between the user-to-content network 10 and the intra-data center network 20. The distributed data center architecture utilizes this equivalence between switch hierarchies in the user-to-content network 10 and the intra-data center network 20 to integrate these two switch domains together to connect computer servers across a distributed user-to-content domain. The user-to-content network 10 has the switch hierarchy as shown in FIG. 1 with a tree topology, namely users 12 to aggregation COs 14 to hub COs 16. The intra-data center network 20 includes servers 22 that connect to TOR or Leaf switches 24 which connect to Spine switches 26. Thus, the intra-data center network 20 has a similar tree topology as the user-to-content network 10 but using the servers 22, the TOR or Leaf switches 24, and the Spine switches 26 to create the hierarchy.

### Data Centers

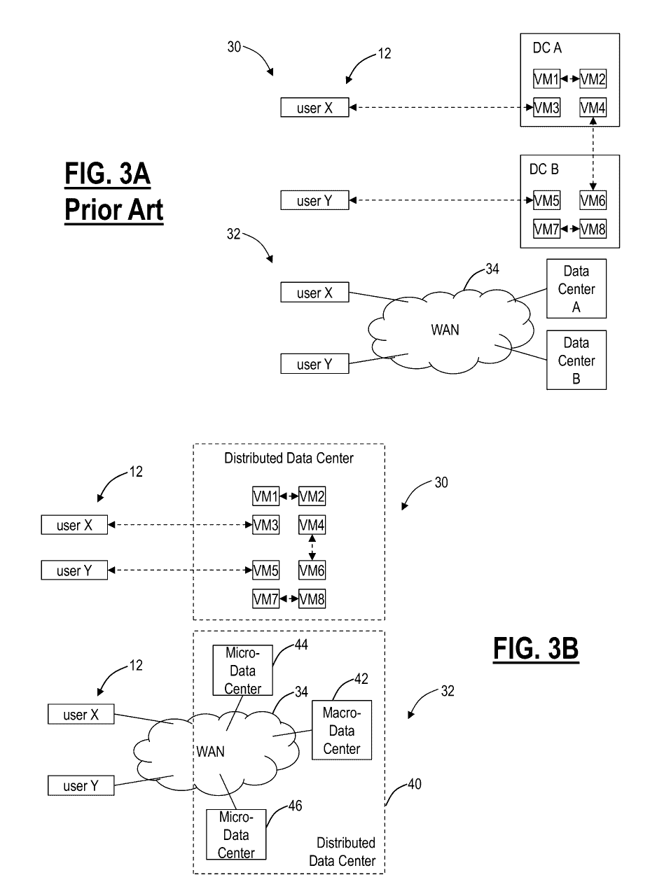

Referring to FIGS. 3A and 3B, in an exemplary embodiment, network diagrams illustrate conventional separate data centers (FIG. 3A) and a distributed data center (FIG. 3B) using the distributed data center architecture. Each of FIGS. 3A and 3B shows two views—a logical view 30 and a physical view 32. The physical view 32 includes actual network connectivity, and the logical view 30 shows connectivity from the user 12 perspective. FIG. 3A illustrates conventional data center connectivity. In this example, User X connects to VM3 located in data center A, and User Y connects to VM5 located in data center B. Both connections are formed across a separate WAN network 34. In FIG. 3B, the physical view 32 includes a distributed data center 40 which includes, for example, a macro data center 42 and two micro data centers 44, 46. The data centers 42, 44, 46 are connected via the WAN and the distributed data center architecture described herein. To the users 12, the data centers 42, 44, 46 appear as the single distributed data center 40. In this case, Users X and Y connect to their respective VMs, which are now logically located in the same distributed data center 40.

The distributed data center 40 expands a single data center fabric and its associated servers/VMs geographically across a distributed data center network domain. In an exemplary embodiment, the distributed data center 40 includes the micro data centers 44, 46 which can be server pods operating as part of a larger, parent data center (i.e., the macro data center 42). The micro data centers 44, 46 (or server pod) are a collection of switches where each switch might subtend one or more switches in a hierarchy as well as servers hosting VMs. The combination of micro- and macro-DCs appears logically to the DC operator as a single data center fabric, i.e., the distributed data center 40.

### Data Center Fabric (DCF)

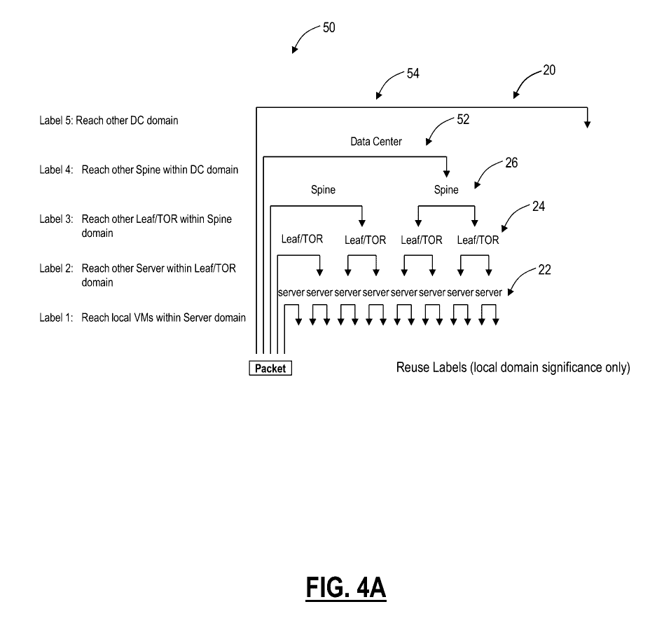

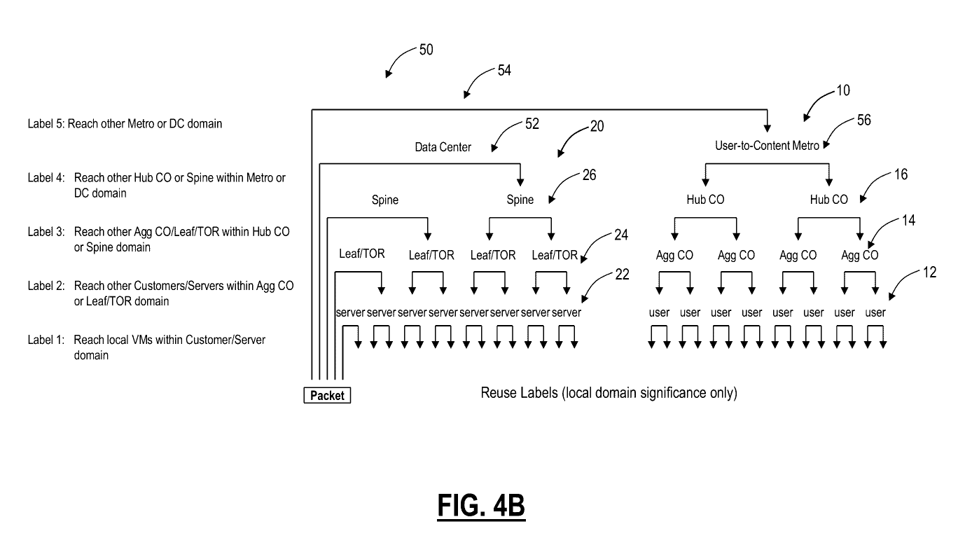

Referring to FIGS. 4A and 4B, in an exemplary embodiment, hierarchical diagrams illustrate a Data Center Fabric (DCF) label structure (of which an HSDN label structure 50 is an example of an ordered and reusable label structure) for an underlay network utilized for connectivity between the data centers 42, 44, 46 in the distributed data center 40. FIG. 4A shows the HSDN label structure 50 for a data center 42, 44, 46, i.e., for the intra-data center network 20. For example, a five-layer hierarchical structure is used—three labels (Labels 1-3) for connectivity within a same data center 42, 44, 46, i.e., communications between the servers 22, the TOR or Leaf switches 24, and the Spine switches 26. The HSDN label structure 50 is an ordered label structure and includes a label 52 for communication between the data centers 42, 44, 46, i.e., the data centers 42, 44, 46 in the distributed data center 40. Finally, a fifth label 54 can be used for communications with other data center domains. Again, HSDN is described in the IETF draft draft-fang-mpls-hsdn-for-hsdc-00, “MPLS-Based Hierarchical SDN for Hyper-Scale DC/Cloud”. To date, HSDN has been proposed for data center underlay communications based on the regular and structured leaf and spine arrangement of a folded Clos data center fabric. HSDN may be regarded as a special case of Segment Routing (SR), with strict topology constraints, limiting number of Forwarding Information Base (FIB) entries per node.

FIG. 4B shows the HSDN label structure 50 illustrating an equivalence between the user-to-content network 10 hierarchy and intra-data center network 20 hierarchy. Specifically, the same labels in the HSDN label structure 50 can be used between the networks 10, 20. The distributed data center architecture utilizes the HSDN label structure 50 in the distributed data center 40 and the WAN 34. In both FIGS. 4A and 4B labels 1-3 can be locally significant only to a particular data center 42, 44, 46 and WAN 34, thus reused across these networks. The labels 4-5 can be globally significant, across the entire network.

A key point about this architecture is that no intermediate IP routing is required in the WAN 34 interconnection network. The WAN 34 uses only MPLS data plane switching with an ordered and reusable label format (e.g., HSDN format) under SDN control. A logically centralized SDN controller makes it possible to avoid IP routing because it knows the topology and a location of all the resources. The SDN controller can then use labels to impose the required connectivity on the network structure, i.e., HSDN. Advantageously, IP routers are not needed because the distributed VMs are all connected to a single Clos switch fabric. Also, because all vSwitches/servers are part of same HSDN label space, any server can stack labels to go through the hierarchy to reach any destination within a remote data center location without needing to pass through a traditional IP Gateway. The common addressing scheme simplifies the operation of connecting any pair of virtual machines without complex mappings/de-mapping and without the use of costly IP routing techniques. Further, when using HSDN and Segment Routing (SR) in the same solution, the compatibility between WAN and DC switching technologies simplifies forwarding behavior.

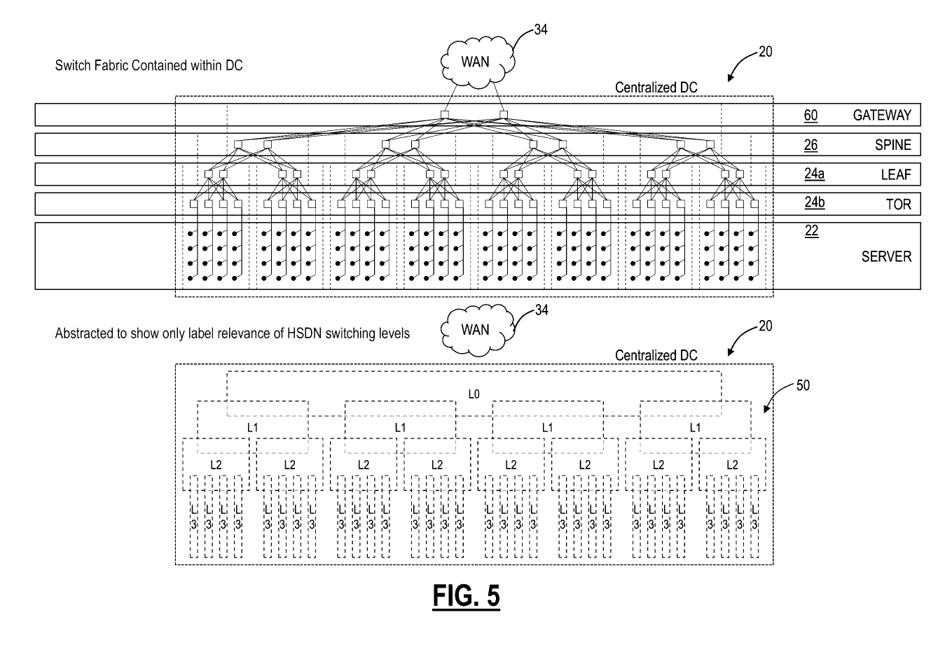

Referring to FIG. 5, in an exemplary embodiment, a network diagram illustrates the intra-data center network 20 with a structured folded Clos tree, abstracted to show the HSDN label structure 50. For example, the intra-data center network 20 can utilize five levels of switches with corresponding labels: (1) for a gateway 60 (at L0), (2) for the Spine switches 26 (at L1), (3) for Leaf switches 24a (at L2), (4) for TOR switches 24b (at L3), and (5) for the servers 22 (at L4). Note, the WAN 34 and the intra-data center network 20 both have a logical hierarchy. Additionally, while not shown, the servers 22 can also have a hierarchy as well which can be mutually independent of the WAN 34.

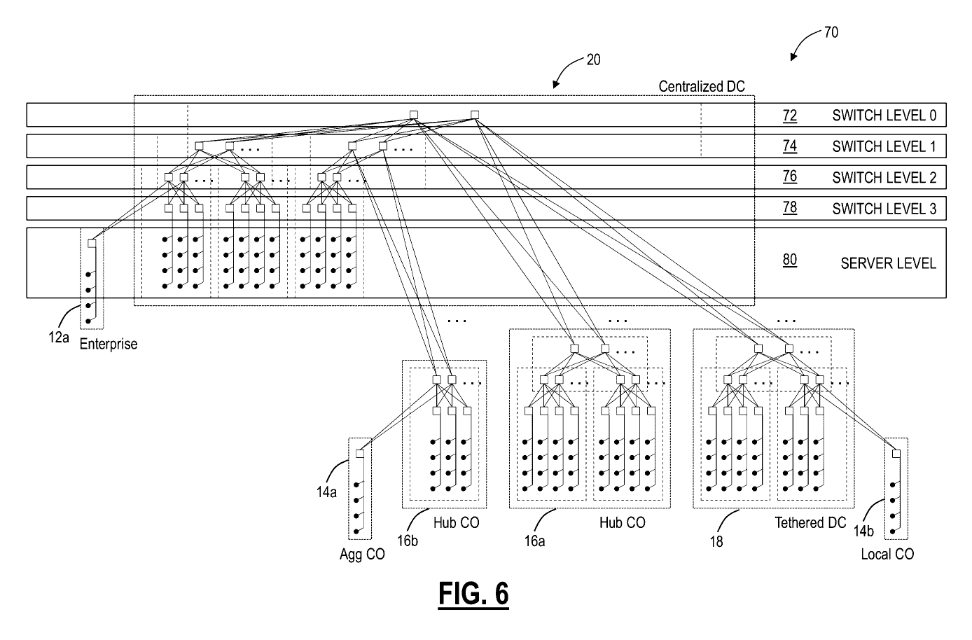

Referring to FIG. 6, in an exemplary embodiment, a network diagram illustrates a network 70 showing the structured folded Clos tree with a generalized multi-level hierarchy of switching domains. Specifically, the network 70 is an implementation of the distributed data center 40, based on a generic, hierarchical, switch tree structure with distributed switch groups. FIG. 6 is similar to FIG. 5 with FIG. 5 showing a single conventional data center 20 and with FIG. 6 showing the data center 20 geographically distributed to position some switches at locations corresponding to a user (enterprise 12a), an aggregation CO 14a, a local CO 14b, hub COs 16a, 16b, and a tethered data center 18. Also, the HSDN label structure 50 in the network 70 is shown with generic switching levels 72-80 (i.e., switching levels 0, 1, 2, 3, and a server level. The interconnections in the network 70 are performed using the HSDN label structure 50 and the generic switching levels 72-80, each with its own label hierarchy. Different data center modular groups (e.g., Switch Level 0, 1, 2, 3) may be distributed to remote sites by the intra-data center network 20.

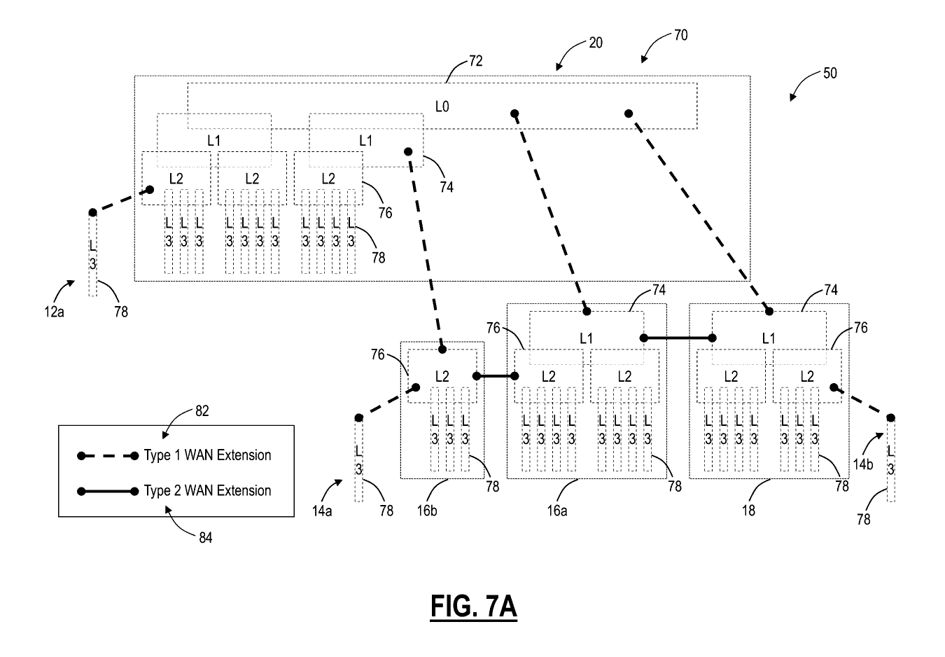

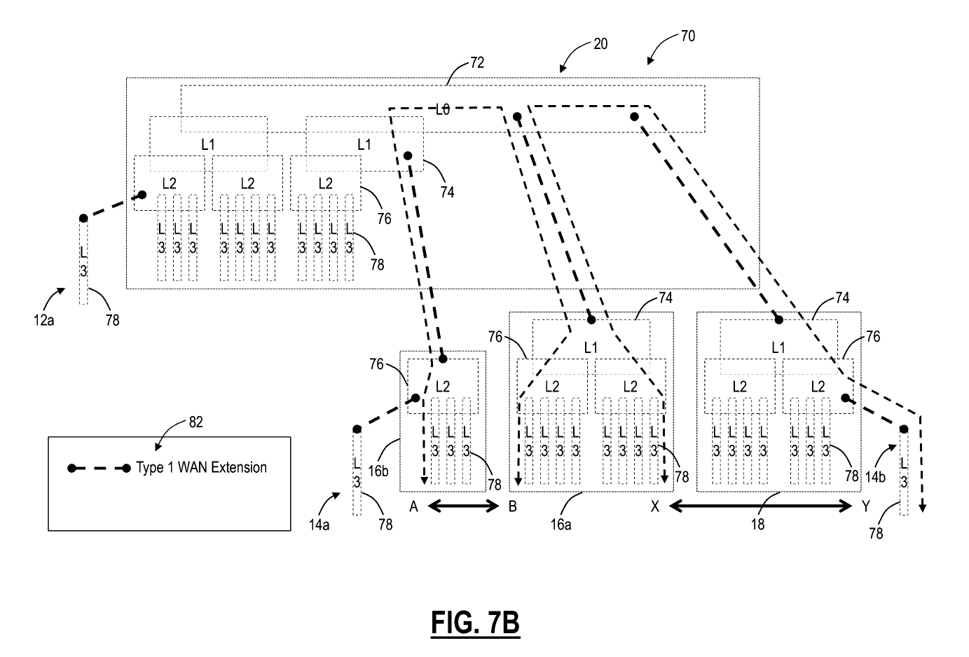

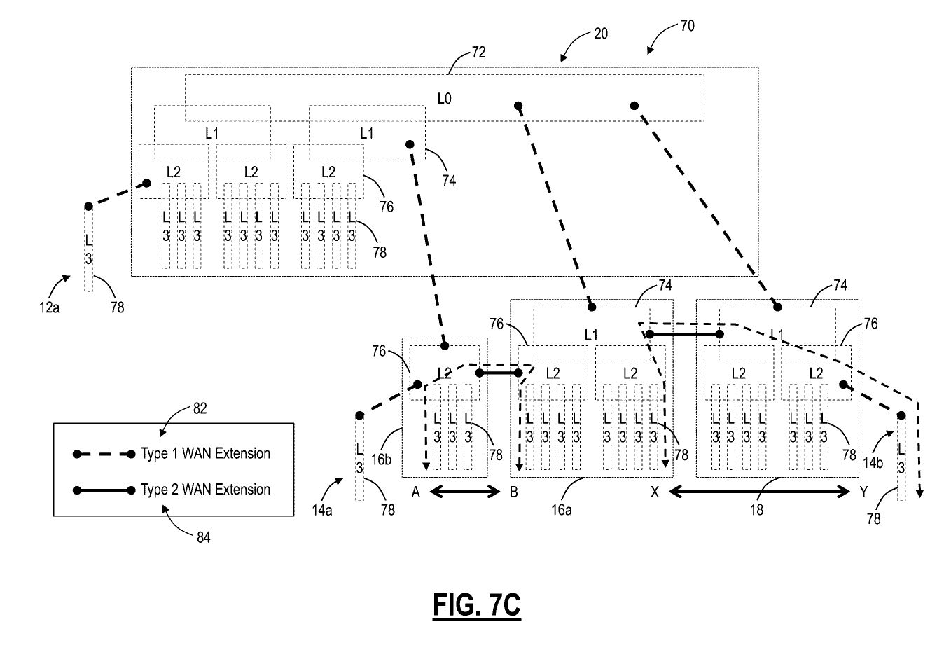

Referring to FIGS. 7A, 7B, and 7C, in an exemplary embodiment, logical network diagrams illustrate connectivity in the network 70 with the HSDN label structure 50 (FIG. 7A) along with exemplary connections (FIGS. 7B and 7C). The HSDN label structure 50 is shown with labels L0, L1, L2, L3 for the switching levels 72, 74, 76, 78, respectively. This logical network diagram shows the network 70 with the various sites and associated labels L0, L1, L2, L3. The HSDN label structure 50 is used to extend the enterprise 12a, the aggregation CO 14b, the local CO 14a, the hub COs 16a, 16b, the tethered data center 18, and the data center 20 across the WAN 34 to form the distributed data center. The distributed data center 40, the HSDN label structure 50, and the network 70 support two types of extensions over the WAN 34, namely a type 1 WAN extension 82 and a type 2 WAN extension 84.

The type 1 WAN extension 82 can be visualized as a North-South, up-down, or βvertical extension, relative to the user-to-content network 10 hierarchy and intra-data center network 20 hierarchy. For example, the type 1 WAN extension 82 can include connectivity from Level 0 switches at L0 in the data center 20 to Level 1 switches at L1 in the hub CO 16a and the tethered data center 18, from Level 1 switches at L1 in the data center 20 to Level 2 switches at L2 in the hub CO 16, from Level 2 switches at L2 in the data center 20 to Level 3 switches at L3 in the enterprise 12a, Level 2 switches at L2 in the hub CO 16b to Level 3 switches at L3 in the aggregation CO 14a, Level 2 switches at L2 in the data center 18 to Level 3 switches at L3 in the local CO 14b, etc.

FIGS. 7B and 7C illustrate examples of connectivity. In FIG. 7B, the type 1 WAN extension 82 is shown. Note, the type 1 WAN extension 82 maintains a rigid HSDN label structure. In FIG. 7C, a combination of the type 1 WAN extension 82 and the type 2 WAN extension 84 are shown for creating shortcuts in the WAN 34 for the distributed data center 40. Note, the type 2 WAN extension 84 merges two Level instances into one for the purpose of a turnaround at that level, thus providing a greater choice of egress points downwards from that level.

The type 2 WAN extension 84 can be visualized as an East-West, side-to-side, or horizontal extension, relative to the user-to-content network 10 hierarchy and intra-data center network 20 hierarchy. For example, the type 2 WAN extension 84 can include connectivity from Level 2 switches at L2 between the hub CO 16b and the hub CO 16a, from Level 1 switches at L1 between the hub CO 16a and the data center 18, etc.

### 3D Folded Clos Arrangement

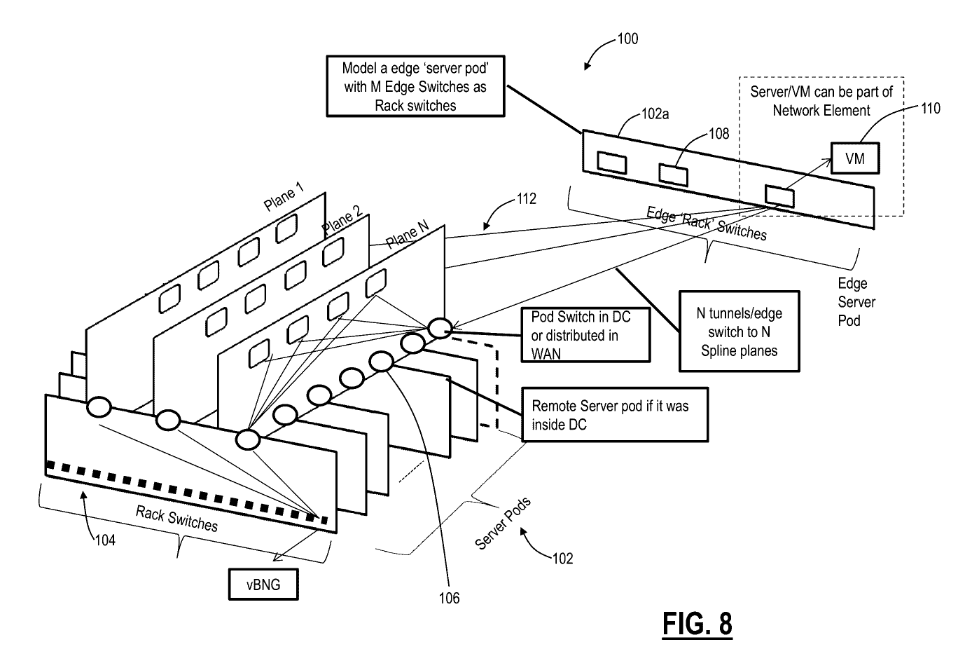

Referring to FIG. 8, in an exemplary embodiment, a logical diagram illustrates a 3D Folded Clos Arrangement 100 with geographically distributed edge ‘rack’ switches. The 3D Folded Clos Arrangement 100 can include server pods 102, each with rack switches 104 and pod switches 106. Servers in the server pods 102 connect to rack switches 104 which in turn connect to the pod switches 106 which can be in the data center 18, 20 or distributed in the WAN 34. A server pod 102a can be modeled with M-edge switches as rack switches 108. Also, a server/VM 110 can be part of a network element. The distributed data center fabric can be formed by extending intra-DC switch-to-switch links 112 across the user-to-content WAN 34. The distributed data center fabric is consistent with traditional data center design and may be based on the generic, hierarchical, fat-tree structure with distributed switch groups or it may be based on the 3D Folded Clos Arrangement 100. In this example, the VM 110 belonging to a micro-DC (the server pod 102a) could be hosted on a server that is part of a WAN 34 operator's network element. The operator of the WAN 34 could offer such a server/VM as a Network Function Virtualization Infrastructure (NFVI) component to a different data center operator. The different data center operator could then use the NFVI component in the distributed data center 40 fabric.

### Geographically Distributed Data Center

In the distributed data center architecture, a single data center fabric and its associated servers/VMs are expanded geographically across a distributed data center network domain. As described above, distributed data center architecture facilities (e.g., with server pods viewed as micro-data centers 44, 46) operate as part of a larger, parent data center (macro data center 42). The micro-data center 44, 46 (or server pod) is a collection of switches where each switch might subtend one or more switches in a hierarchy as well as servers hosting VMs. The combination of micro and macro data centers 42, 44, 46 appears logically to the data center operator as the distributed data center 40. Servers/VMs and switches in the micro-data center 44, 46 are part of the same distributed data center 40 that includes the macro data center 42. The overlay network of VMs belonging to a given service, i.e., a Virtual Network (VN), is typically configured as a single IP subnet but may be physically located on any server in any geographic location. The addressing scheme used to assign IP addresses to VMs in the overlay network, where some of the VMs are located at the micro-data center 44, 46, is the same as used in the macro data center 42.

MPLS forwarding is used as the basic transport technology for an underlay network. Note, the underlay network is the key enabler of the distributed data center architecture. Two underlay networks may be considered for the distributed data center architecture; (i) a data center underlay network and (ii) a WAN underlay network. These two underlay networks could be implemented with (a) a common identifier space or (b) different identifier spaces for the data center network domain and the WAN domain. For example, the mode of operation might be related to the ownership of the data center fabric (including the NFVI component at a micro data center 44, 46) versus the WAN 34. It is important to note a distinction between the ‘unification of label spaces’ and ‘overlay tunneling’.

Unification of Label Spaces—for a common data center/WAN identifier space, the distributed data center 40 fabric (including any NFVI components at a micro data center 44, 46) and the WAN 34 are considered to be a unified identifier domain. The distributed data center 40 fabric between VMs operates as a separately-administered identifier domain to allow use of a single identifier space in a data center underlay network to identify a tunnel endpoint (e.g., such as Spine or Leaf or TOR switch 24, 26).

Overlay Tunneling—for data center/WAN identifier spaces, the WAN 34 endpoints, e.g., Aggregation Routers (ARs) and gateways 60, are interconnected with tunnels using an identifier space that is separate from that used for the underlay tunnels of the distributed data center 40 for interconnecting servers/VMs.

No intermediate routing is required in the WAN 34 interconnection network. The WAN 34 uses only MPLS switching. IP routers are not needed because the distributed VMs are all part of a single Clos fabric. Also, because all vSwitches/servers are part of same MPLS label space (e.g., the HSDN label structure 50), a tethered server can stack labels to go through the hierarchy to reach destination within a remote data center location without needing to pass through a traditional IP gateway 60.

### Distributed VM Connectivity

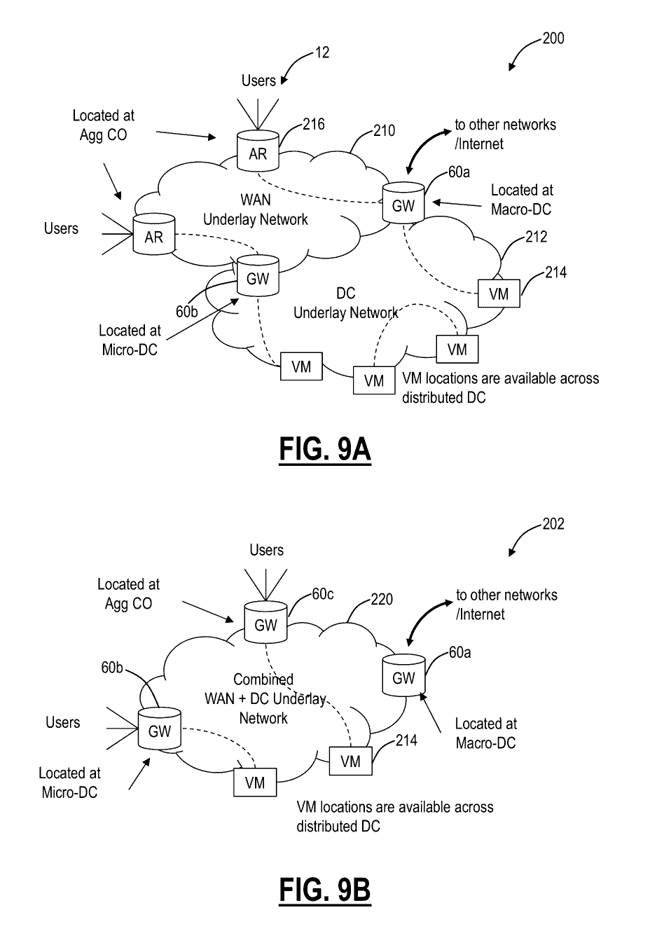

Referring to FIGS. 9A and 9B, in an exemplary embodiment, network diagrams illustrate networks 200, 202 for distributed VM connectivity. Specifically, the network 200 is one exemplary embodiment, and the network 202 is another exemplary embodiment 202. In FIG. 9A, the network 200 includes a WAN underlay network 210 and a data center underlay network 212. The two networks 210, 212 interconnect with gateways 60a, 60b. The gateway 60a can be located at the macro data center 42, and the gateway 60b can be located at the micro data center 44, 46. There are various VMs 214 interconnected by the data center underlay network 212 and the WAN underlay network 210 can include aggregation routers 216 or the like (e.g., located at the aggregation CO 14b) connected to the users 12. The network 202 includes a combined WAN and data center underlay network 220 which interconnects the gateways 60a, 60b, a gateway 60c at the aggregation CO 14b, and the VMs 214.

In FIG. 9B, the network 202 includes a combined WAN and data center underlay network 220 which interconnects the gateways 60a, 60b, a gateway 60c at the aggregation CO 14b, and the VMs 214. Here, the servers/VMs 214 and switches in the micro-data centers 44, 46 are part of the same distributed data center 40 that includes the macro data center 42. An overlay network of VMs 214 belonging to a given service, i.e., a Virtual Network (VN), are typically configured as a single IP subnet but may be physically located on any server in any geographic location. The addressing scheme used to assign IP addresses to the VMs 214 in the overlay network, where some of the VMs 214 are located at the micro data center 44, 46, is the same as used in the macro data center 42. Additionally, the two underlay networks 210, 212 may be considered for the distributed data center; (i) the data center underlay network 212 and (ii) the WAN underlay network 210. These two underlay networks 210, 212 could be implemented with different identifier spaces or a common identifier space. This might also be related to the ownership of the data center fabric including the NFVI component at the micro data center 44, 46 versus the WAN 34.

In an exemplary embodiment, the WAN endpoints, e.g., Aggregation Routers (ARs) and Gateways, are interconnected with tunnels using an identifier space that is separate from that used for the underlay network of the distributed data center for interconnecting servers/VMs 214.

In another exemplary embodiment, the distributed data center 40 fabric (including any NFVI components at a micro data center) and the WAN 34 are considered to be a single network. The distributed data center 40 fabric between VMs operates as a single domain to allow use of a single identifier space in the data center underlay network 212, 220 to identify a tunnel endpoint (e.g., such as spine or leaf or top of rack switch). In a further exemplary embodiment, the WAN and data center underlay networks 210, 212, 220 may be operated as a carefully composed federation of separately-administered identifier domains when distributed control (e.g., external Border Gateway Protocol (eBGP)) is used. Here, an in-band protocol mechanism can be used to coordinate a required label stack for a remote device, for both rigid and unmatched switch hierarchies, when the remote device does not have a separate controller. One such example of the in-band protocol mechanism is described in commonly-assigned U.S. patent application Ser. No. 14/726,708 filed Jun. 1, 2015 and entitled “SOFTWARE DEFINED NETWORKING SERVICE CONTROL SYSTEMS AND METHODS OF REMOTE SERVICES,” the contents of which are incorporated by reference.

### WAN Extension Using Hierarchical SDN (HSDN)

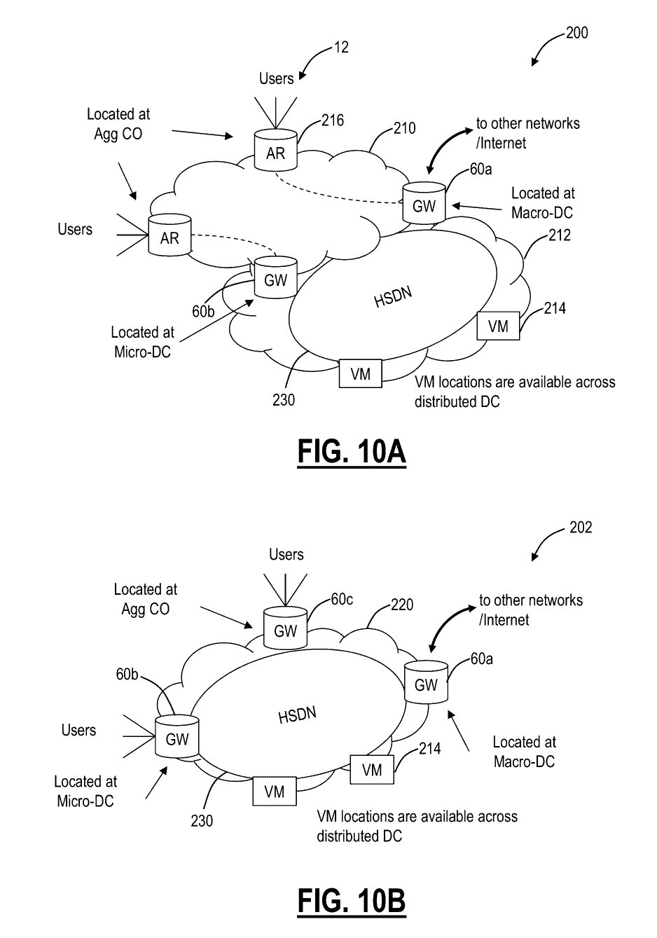

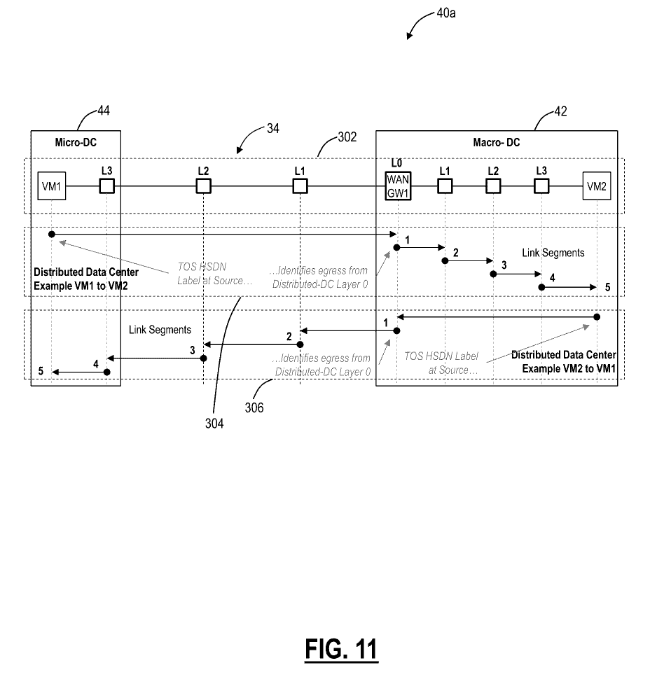

Referring to FIGS. 10A and 10B, in an exemplary embodiment, network diagrams illustrate the networks 200, 202 using HSDN 230 for WAN extension. Here, the network 200 utilizes HSDN 230 in the data center underlay network 212 to extend the data center underlay network 212 over the WAN 34. The network 202 utilizes HSDN 230 in the combined WAN and data center underlay network 220. The HSDN 230 can operate as described above, such as using the HSDN label structure 50.

In the distributed data center architecture, packet forwarding uses domain-unique MPLS labels to define source-routed link segments between source and destination locations. Solutions are similar to the approaches defined by (i) Segment Routing (SR) and (ii) Hierarchical SDN (HSDN). The distributed data center architecture unifies the header spaces of the data center and WAN domains by extending the use of HSDN (i) across the WAN 34 or (ii) where the NFVI of a data center extends across the WAN 34. It also applies SR in some embodiments as a compatible overlay solution for WAN interconnection. In all cases, a VM/server 214 in the macro data center 42 or the micro-data centers 44, 46 will be required to map to one or more switching identifiers associated with the underlay network 212, 220. A SDN controller determines the mapping relationships.

In an exemplary embodiment, an underlay network formed by one or more network elements is configured to provide a distributed data center architecture between at least two data centers. The underlay network includes a first plurality of network elements communicatively coupled to one another forming a data center underlay; and a second plurality of network elements communicatively coupled to one another forming a Wide Area Network (WAN) underlay, wherein at least one network element of the first plurality of network elements is connected to at least one network element of the second plurality of network elements, wherein the data center underlay and the WAN underlay utilize an ordered label structure between one another to form the distributed data center architecture. The ordered label structure can include a unified label space between the data center underlay and the WAN underlay, such that the data center underlay and the WAN underlay require no re-mapping function as packets move between them. The ordered label structure can include a unified label space between at least two data centers connected by the data center underlay, and tunnels in the WAN underlay connecting at least two data centers.

The distributed data center architecture only uses Multiprotocol Label Switching (MPLS) in the intra (geographically distributed) data center WAN with Internet Protocol (IP) routing at edges of the geographically distributed data center architecture. Note that the edges of the geographically distributed data center may also connect to a different WAN (such as the public Internet or a VPN). The ordered label structure can utilize Multiprotocol Label Switching (MPLS) with Hierarchical Software Defined Networking (HSDN) control. The ordered label structure can include a rigid switch hierarchy between the data center underlay and the WAN underlay. The ordered label structure can include a switch hierarchy between the data center underlay and the WAN underlay where the number of hops is not matched in opposite directions. At least one of the network elements in the first plurality of network elements and the second plurality of network elements which includes a packet switch communicatively coupled to a plurality of ports and configured to perform Multiprotocol Label Switching (MPLS) per Hierarchical Software Defined Networking (HSDN) control using the ordered label structure, and a media adapter function configured to create a Wavelength Division Multiplexing (WDM) signal for the second port over the WAN. A first device in a first data center can be configured to communicate with a second device in a second data center using the ordered label structure to perform Multiprotocol Label Switching (MPLS) per Hierarchical Software Defined Networking (HSDN) control using the ordered label structure, without using Internet Protocol (IP) routing between the first device and the second device.

### Distributed Data Center Using HSDN

FIGS. 11-17 illustrate various examples of the distributed data center architecture. Again, the distributed data center architecture is a new underlay network approach for a geographically distributed data center based on Hierarchical SDN (HSDN) and segment routing (SR). Two modes of operation are described using use cases based on (a) common DC/WAN identifier spaces and (b) different DC/WAN identifier spaces. The distributed data center architecture extends the use of HSDN (i) between DC facilities across the WAN or (ii) where the NFVI of a DC extends across the WAN. SR is applied in some cases as a compatible overlay solution for tunneled WAN interconnection. When using HSDN and SR in the same solution, the compatibility between WAN and DC switching technologies simplifies forwarding behavior. Virtual machines and servers are logically operated as part of one single DC fabric using a single addressing scheme. The common addressing scheme simplifies the operation of connecting any pair of virtual machines without complex mappings/de-mapping and without the use of costly IP routing techniques.

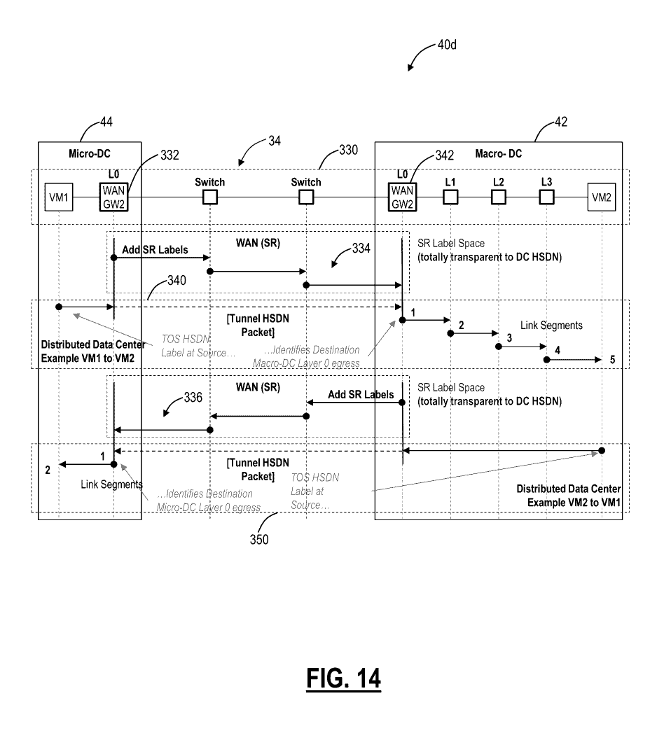

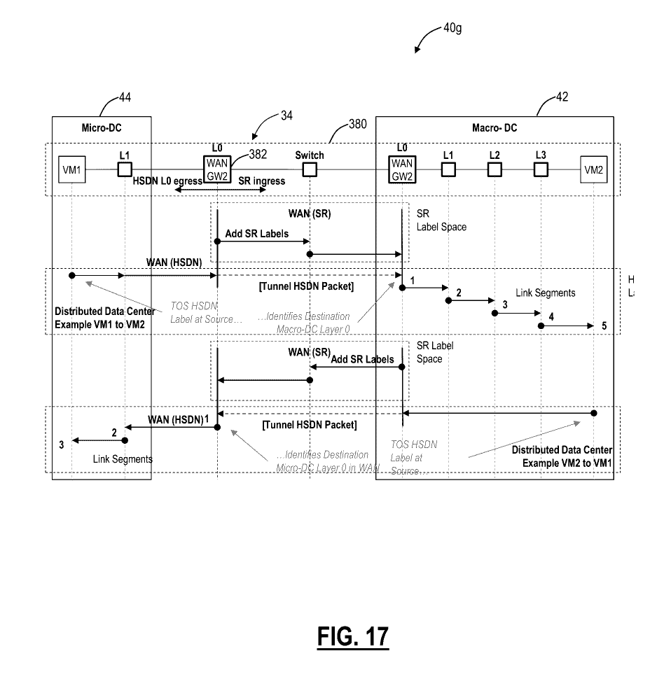

The underlay networks 210, 212, 220 previously referenced contemplate configurations where the distributed data center 40 and the WAN employ a single identifier space or separate and distinct identifier spaces. FIGS. 11-13 illustrate an exemplary embodiment for a case of a single identifier space for both the distributed data center 40 (including NFVI) and the WAN 34. FIGS. 14-16 illustrate an exemplary embodiment of a case of separate identifier spaces for the distributed data center 40 (including NFVI) and the WAN 34. FIG. 17 illustrates an exemplary embodiment of a case of both a combined identifier domain and separate identifier domains for the distributed data center 40 (including NFVI) and the WAN 34.

Common DC/WAN Underlay with Rigid Matched Hierarchy

Referring to FIG. 11, in an exemplary embodiment, a network diagram illustrates a distributed data center 40a between a macro data center 42 and a micro data center 44 illustrating a common DC/WAN underlay with a rigid matched hierarchy. A layer 302 illustrates physical hardware associated with the distributed data center 40a. Specifically, the micro data center 44 includes a virtual machine VM1 and a switch at L3, the WAN 34 includes switches at L2, L1, and the macro data center 42 includes a WAN GW1 at L0, switches at L1, L2, L3, and a virtual machine VM2. FIG. 11 requires a unified label space which imposes a rigid switch hierarchy (matched by a label hierarchy) across the WAN 34 that is equivalent to the HSDN approach for a data center hierarchy. When the WAN 34 is a structured aggregation backhaul network, the same label structure is used to forward MPLS packets between the VM1, VM2, traveling up and down the WAN hierarchy and data center hierarchy using HSDN. The WAN GW1 can be an L0 switch that also offers reachability over the WAN 34 and is known (via SDN or BGP) to offer routes to remote instances of the single distributed data center address space.

In HSDN, a single label gets a packet to the top switch of the tree that subtends both source and destination (e.g., spine switch for large scale or leaf switch for local scale). In the distributed data center 40a, the top of the tree is depicted by a WAN Gateway (WAN GW1), which offers reachability of endpoint addresses over the entire distributed data center 40a (including the WAN 34). Hence, the top label in the label stack implicitly identifies the location (the micro data center 44, the aggregation CO 14b, the local CO 14a, the hub CO 16, or the macro data center 42) as well as the topmost layer in that location. The rest of the label stack is needed to control the de-multiplexing from the topmost switch (e.g. a spine switch) back down to the destination.

The approach in the distributed data center 40a may be preferred when using a distributed control plane. It eases the load on the control plane because the rigid switching hierarchical structure allows topology assumptions to be made a priori. In the context of the topological structure of the user-content network 10, a hierarchical tree of connectivity is formed between the users 12 located at customer premises, the aggregation CO 14b, the local CO 14a, the hub CO 16, etc. In many networks, this topological hierarchy may be regarded as equivalent to the rigid hierarchy typically imposed within a data center. Imposing such a simplifying structure on a metro network allows the application of HSDN across the metro WAN 34 to enable high levels of east-west scaling and simplified forwarding. Optionally, if the WAN 34 has an arbitrary switch topology, then a variation of the above could use Segment Routing (SR) across the WAN 34 domain. SR uses matching waypoints, compatible label structure and forwarding rules, but with more loosely-constrained routes.

The WAN 34 likely has more intermediate switches than the data centers 42, 44. If an operator has control of the data centers 42, 44 and the WAN 34, then the operator can match the data centers 42, 44 switch hierarchy logically across the WAN 34 using label stack to define a set of waypoints. The distributed data center 40a can optionally use Segment Routing (SR) or HSDN. For SR, when the WAN 34 is an arbitrary topology, loose routes are used with matching waypoints with Segment Routing (SR). For HSDN, when the WAN 34 is a structured aggregation backhaul, fixed routes are used with logically matching waypoints with HSDN. Note, HSDN is a special case of SR, with strict topology constraints (limiting number of FIB entries per node).

The distributed data center 40a is illustrated with two layers 304, 306 to show example connectivity. The layer 304 shows connectivity between the VM1 to the VM2, and the layer 306 shows connectivity between the VM2 to the VM1. In the layer 304, a label for a packet traveling left to right between the VM1 to the VM2 is added at the top of stack (TOS), such as an HSDN label that identifies the WAN GW1 L0 switch. The packet includes 5 total HSDN labels including the HSDN label that identifies the WAN GW1 L0 switch and four labels in the HSDN label space for connectivity within the macro data center 42 to the VM2. Similar, in the layer 306, a label for a packet traveling right to left between the VM2 to the VM1 is added at the top of stack (TOS), such as an HSDN label that identifies the WAN GW1 L0 switch. The packet includes 5 total HSDN labels including the HSDN label that identifies the WAN GW1 L0 switch and four labels in the HSDN label space for connectivity from the WAN 34 to the micro data center 44 to the VM1.

Common DC/WAN Underlay with WAN Hairpin

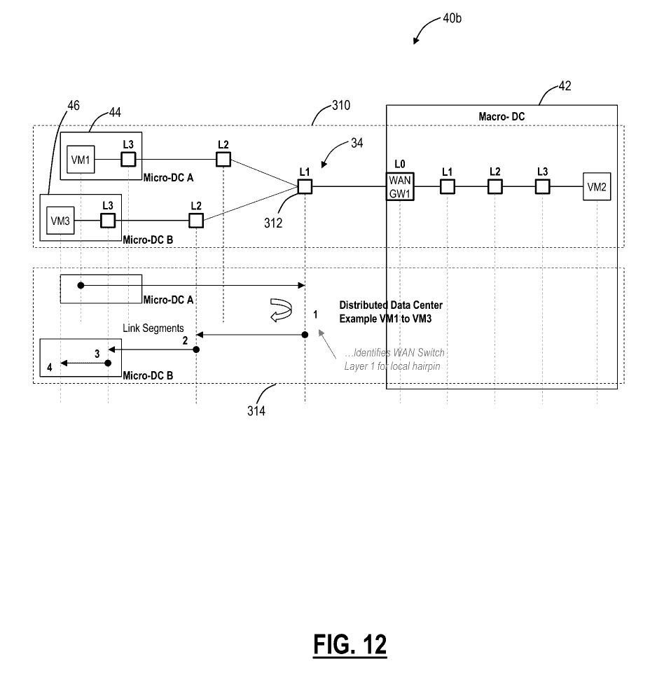

Referring to FIG. 12, in an exemplary embodiment, a network diagram illustrates a distributed data center 40b between a macro data center 42 and two micro data centers 44, 46 illustrating a common DC/WAN underlay with a WAN hairpin. A layer 310 illustrates physical hardware associated with the distributed data center 40b. Specifically, the micro data center 44 includes a virtual machine VM1 and a switch at L3, the micro data center 46 includes a virtual machine VM3 and a switch at L3, the WAN 34 includes switches at L2, L2, L1, and the macro data center 42 includes a WAN GW1 at L0, switches at L1, L2, L3, and a virtual machine VM2. The unified label space variation shown in FIG. 12 describes the communication between VMs located in the two micro data centers 44, 46 that participate in the same distributed data center 40b. If a single operator has control over both the WAN 34 and the data center switches, then an HSDN link may hairpin at an intermediate switch 312 located in the WAN, which benefits from low latency and avoids a traffic trombone through the macro data center 42. In a layer 314, the VM1 communicates with VM3 via the WAN 34 switch 312 at L1, specifically through a label at L1 for a local hairpin. This hairpin switching at a switch level lower than Level 0, is equivalent to local hairpin switching inside a traditional data center, except the function has been extended to the WAN 34.

Common DC/WAN Underlay with Unmatched Hierarchy

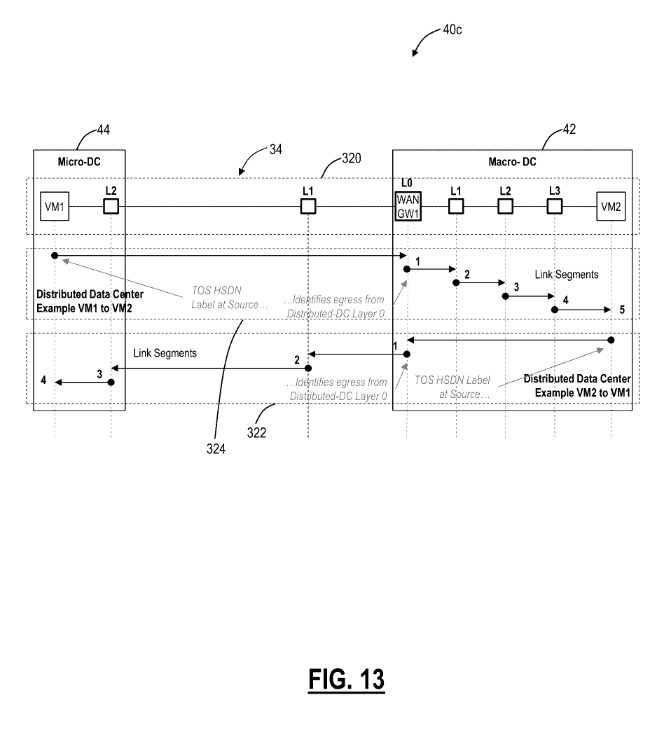

Referring to FIG. 13, in an exemplary embodiment, a network diagram illustrates a distributed data center 40c between a macro data center 42 and a micro data center 44 illustrating a common DC/WAN underlay with an unmatched hierarchy. A layer 320 illustrates physical hardware associated with the distributed data center 40c. Specifically, the micro data center 44 includes a virtual machine VM1 and a switch at L3, the WAN 34 includes switches at L2, L1, and the macro data center 42 includes a WAN GW1 at L0, switches at L1, L2, L3, and a virtual machine VM2. The unified label space variation shown in FIG. 13 describes the situation where the forwarding model between a pair of VMs is asymmetrical. A path between a pair of physically remote VMs may use a different number of switching stages (levels) to control the de-multiplexing path from topmost switch back down to the destination based on the relative switch hierarchies of the different data center 42, 44 facilities.

Because of this variation in switch levels between a source server and a destination server, the HSDN Controller must always provide a complete label stack for every destination required; the number of labels comes as an automatic consequence of this stack. Using the example shown in the distributed data center 40c, to send a packet right to left from the macro data center 42 VM2 to the micro data center 44 VM1 (layer 322) may only require the addition of 4 labels if the micro data center 44 is only one level of switching deep (e.g., a TOR/Server layer). In the opposite left to right direction (layer 324), 5 labels are required to navigate down through the macro data center 42 hierarchy because it has multiple levels of switching (e.g., Spline/Leaf/TOR/Server layers). To support this asymmetry, labels can be identified through the use of a central SDN controller. Alternatively, each switching point would be required to run a distributed routing protocol, e.g., eBGP used as an IGP, with a single hop between every BGP speaker. The unmatched hierarchy works because, upstream, the switch at L1 in the WAN 34 always passes traffic on the basis of the L0 label, and, downstream, it pops its “own” label to expose the next segment. The forwarding model is basically asymmetric, i.e., for an individual switch there is no forwarding symmetry between UP and DOWN.

### Different DC/WAN Identifier Space: Single Distributed Data Center

Referring to FIG. 14, in an exemplary embodiment, a network diagram illustrates a distributed data center 40d between a macro data center 42 and a micro data center 44 illustrating separate DC and WAN underlays for a single distributed data center. A layer 330 illustrates physical hardware associated with the distributed data center 40d. Specifically, the micro data center 44 includes a virtual machine VM1 and a WAN GW2 switch at L0 332, the WAN 34 includes two switches, and the macro data center 42 includes a WAN GW1 at L0, switches at L1, L2, L3, and a virtual machine VM2. The WAN GW2 switch at L0 332 is a switch that offers reachability over the WAN 34 to the micro data center 44 and participates in HSDN and maps HSDN packets to/from a WAN Segment Routing (SR) tunnel. In the example of FIG. 14, the WAN GW2 switch at L0 332 is an L0 switch with SR tunnel termination functionality, e.g., the WAN GW2 switch at L0 332 could be a Packet-Optical Transport System (POTS).

In the example of FIG. 14, an HSDN connection belonging to the distributed data center 40d uses Segment Routing (SR) connectivity to navigate through the WAN 34 domain. Specifically, there is an SR tunnel 334 between the micro data center 44 and the macro data center 42 and an SR tunnel 336 between the macro data center 46 and the micro center 42. A sending VM adds an HSDN label stack for the destination VM (i.e., the labels that would normally be needed if the WAN 34 did not exist), but the destination VM happens to be located in a remote data center location. At launch, the HSDN stack has the target switch label as its Bottom of Stack (BoS). It sends the packet to its own WAN Gateway (i.e., the WAN GW2 switch at L0 332).

In addition to providing address reachability information (per WAN GW1), the WAN GW2 switch at L0 332 also participates in both the HSDN and SR domains. The example in FIG. 14 illustrates the WAN GW2 switch at L0 332 as a Layer 0 switch with additional SR tunnel termination function. The WAN GW2 switch at L0 looks up the address of the target vSwitch/ToR, indicated by the then Top of Stack (TOS) HSDN label, and pushes onto the stack the required Segment Routing (SR) transport labels to direct the (HSDN) packet to the remote DC location. The SR label space is transparent to the DC HSDN label space. A SR node knows where to send a packet because the ToS HSDN label identifies the remote DC topmost switch (or the WAN GW2 switch at L0 332). At the remote DC, and after the last SR label has been popped, the original HSDN labels are used to de-multiplex down through the remote hierarchy to the destination VM. Optionally, other network technologies may be used to tunnel the DC HSDN packets through the WAN 34. For example, Dense Wave Division Multiplexing (DWDM), OTN, Ethernet and MPLS variants may be applied. SR is shown as an example because of its simplicity, flexibility, packet granularity and functional compatibility with HSDN.

At a layer 340, an example is shown communicating from VM1 to VM2. Here, at the TOS, an HSDN label identifies a WAN GW2 switch at L0 342, along with 5 HSDN labels from the WAN GW2 switch at L0 342 to the VM2 in the macro data center 42. The TOS label causes the communication over the SR connectivity 334, and the HSDN labels direct the communication to the VM2 in the macro data center 42. At a layer 350, an example is shown communicating from VM2 to VM1. Here there is a TOS HSDN label identifying the WAN GW2 switch at L0 332 and 2 HSDN labels to the VM2. The HSDN packets are tunneled through the WAN 34, and the distributed data center 40d operates as a single data center with a common addressing scheme. The use of SR in the WAN 34 is compatible with HSDN.

### Different DC/WAN Identifier Space: Dual Macro Data Center

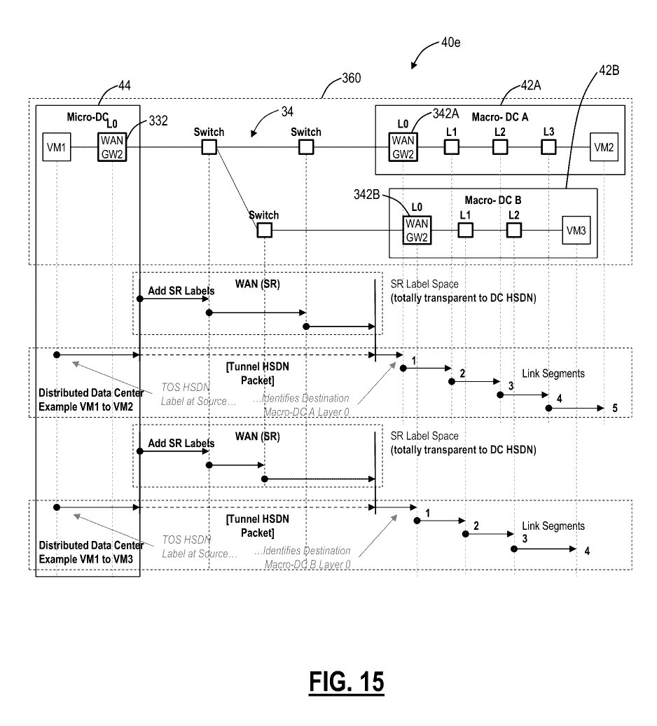

Referring to FIG. 15, in an exemplary embodiment, a network diagram illustrates a distributed data center 40e between macro data centers 42A, 42B and a micro data center 44 illustrating separate DC and WAN underlays for a dual macro data center. A layer 360 illustrates physical hardware associated with the distributed data center 40e. Specifically, the micro data center 44 includes a virtual machine VM1 and a WAN GW2 switch at L0 332, the WAN 34 includes three switches, the macro data center 42A includes a WAN GW2 switch at L0 342A, switches at L1, L2, L3, and a virtual machine VM2, and the macro data center 42B includes a WAN GW2 switch at L0 342B, switches at L1, L2, and a virtual machine VM3. The connectivity variation shown here in FIG. 15 describes a situation where a VM located in the micro data center 44 (e.g. VM1) creates two separate virtual links to two different VMs (e.g. VM2 and VM3) located in two separate macro data centers 42A, 42B. All data centers 42A, 42B, 44 participate in the single distributed data center 40e. This example of dual-homing follows the same process described above. The HSDN TOS label at the source VM identifies the destination WAN GW2 342A, 342B associated with the macro data centers 42A, 42B. The sending WAN GW2 then maps the HSDN packet to the correct SR port used to reach the macro data centers 42A, 42B.

### Multiple Separate Data Center and WAN Underlays

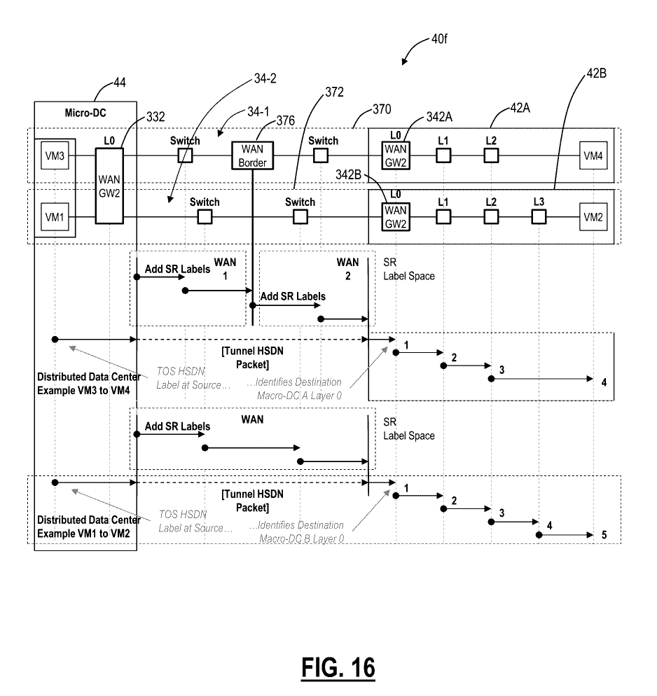

Referring to FIG. 16, in an exemplary embodiment, a network diagram illustrates a distributed data center 40f between macro data centers 42A, 42B and a micro data center 44 illustrating separate DC and WAN underlays for a dual macro data center. Layers 370, 372 illustrate physical hardware associated with the distributed data center 40f. Specifically, the micro data center 44 includes virtual machines VM1, VM3 in a same server and a WAN GW2 switch at L0 332, a WAN 34-1 includes two switches and a border switch 376, a WAN 34-2 includes two switches, the macro data center 42A includes a WAN GW2 switch at L0 342A, switches at L1, L2, and a virtual machine VM4, and the macro data center 42B includes a WAN GW2 switch at L0 342B, switches at L1, L2, L3, and a virtual machine VM2. The underlay connectivity variation shown in FIG. 16 describes a situation where different VMs located in the micro data center 44 (e.g. VM1 and VM3) participate in different distributed data centers associated with different macro data centers 42A, 42B operated by different DC operators. FIG. 16 also illustrates a further option where a virtual link is connected across multiple WAN domains. In the example, VM3 connects to VM4 across WAN 1 and WAN 2. Again, while SR is described as the underlay connectivity technology, other network technologies may be applied in the WAN.

### Hybrid Common and Different Data Center and WAN Identifier Space

Referring to FIG. 17, in an exemplary embodiment, a network diagram illustrates a distributed data center 40g between a macro data center 42 and a micro data center 44 illustrating a hybrid common and different data center and WAN identifier spaces. A layer 380 illustrates physical hardware associated with the distributed data center 40g. Specifically, the micro data center 44 includes a virtual machine VM1 and a switch at L1, the WAN 34 includes a WAN GW2 switch at L0 382 and another switch, and the macro data center 42 includes a WAN GW2 at L0, switches at L1, L2, L3, and a virtual machine VM2. The WAN GW2 switch at L0 382 can include a Segment Routing (SR) interface that originates and terminates SR connectivity in the WAN 34 (Removes edge of L0==UP0 domain from the micro data center 44). The WAN GW2 switch at L0 382 is an L0 switch located in WAN with WAN GW2 function. This provides improved address scaling at the macro data center 42 in a large network with many micro data centers 44, i.e., many L1 addresses are reused behind this WAN L0 switch.

In the example of FIG. 17, both HSDN and SR are applied in the WAN 34. It is, therefore, a combination of unified and unaligned label spaces. In the case of a large network where many micro data centers 44 are tethered to a macro data center 42, address scaling at the macro data center 42 WAN GW2 is of concern. This option moves the L0 switch from the micro data centers 44 (as was described in earlier examples) into the WAN 34 and defines the remote WAN GW2 function in the WAN 34 domain. By doing this, this WAN GW2 and L0 switch are now shared amongst many micro data centers 44. Many micro data center 44 L1 addresses are now reused behind the WAN GW2 switch at L0 382, thus reducing the control plane scaling concern at the macro data center 42 WAN GW2. This change also moves the SR termination function to the WAN 34. Consequently, WAN connectivity from each micro data center 44 to the macro data center 42 is partially connected through the SR domain. In FIG. 17, HSDN packets are tunneled through the SR portion of the WAN 34, the distributed data center 40g operates a single data center with a common addressing scheme, with the use of SR in the WAN 34, which is compatible with HSDN.

### SDN Control

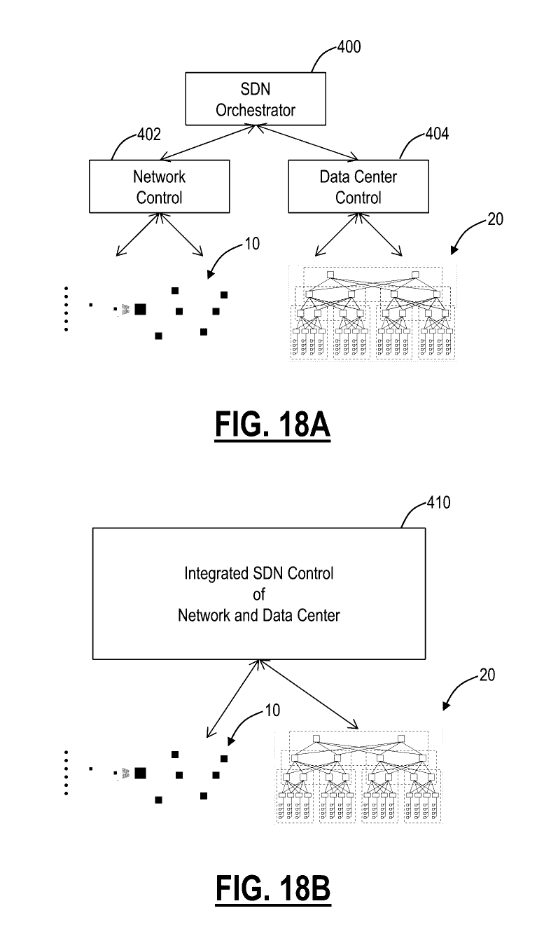

Referring to FIGS. 18A and 18B, in an exemplary embodiment, network diagrams illustrate options for Software Defined Network (SDN) control and orchestration between the user-content network 10 and the data center network 20. FIG. 18A illustrates an exemplary embodiment with an SDN orchestrator 400 providing network control 402 of the user-content network 10 and providing data center control 404 of the data center network 20. FIG. 18B illustrates an exemplary embodiment of integrated SDN control 410 providing control of the user-content network 10 and the data center network 20. SDN-based control systems can be used to turn up and turn down virtual machines, network connections, and user endpoints, and to orchestrate the bandwidth demands between servers, data center resources and WAN connection capacity.

In an exemplary embodiment, the SDN control system may use separate controllers for each identifier domain as well as multiple controllers, e.g. (1) between data center resources and (2) between network resources. In a multi-controller environment, the HSDN domain can be orchestrated across different operators' controllers (independent of the WAN 34) where one controller is used for the macro data center 42 and other controllers are used for the micro data centers 44, and the end-to-end HSDN domain can be orchestrated with additional WAN interconnect controller(s) if needed. In another exemplary embodiment, when a common architecture is proposed across the WAN and the distributed data center, a single SDN control system may be used for the whole integrated network. In a further exemplary embodiment, to distribute the addresses of VMs across the network, all vSwitches register the IP addresses of the VMs which they are hosting with a Directory Server. The Directory Server is used to flood addresses to all vSwitches on different server blades. In one implementation, a Master Directory Server is located in the macro data center 42, and Slave Directory Servers are located in micro data centers 44 to achieve scaling efficiency. In another implementation a distributed protocol such as BGP is used to distribute address reachability and label information. In a further exemplary embodiment, MPLS labels are determined by a Path Computation Element (PCE) or SDN controller and added to packet content at the source node or at a proxy node.

Common DC/WAN Underlay with Rigid Matched Hierarchy

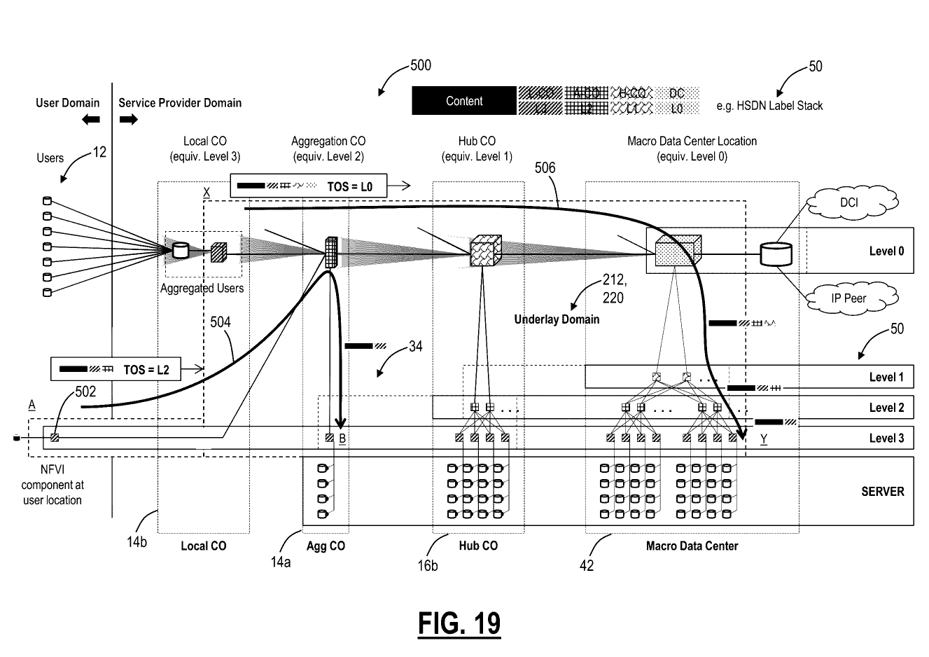

Referring to FIG. 19, in an exemplary embodiment, a network diagram illustrates a network 500 showing integrated use of an HSDN label stack across the WAN 34 and the distributed data center 40. Again, the HSDN label structure 50 is used to extend the users 12, the aggregation CO 14b, the local CO 14a, the hub CO 16 across the WAN 34 to form the distributed data center 40 previously described. For a data center underlay network 212, 220, it uses a common DC/WAN identifier space for MPLS forwarding. FIG. 19 illustrates how traffic may flow across the user-to-content network 10 domain. Users connect to a service provider's distributed data center 40 through an aggregation tree with, for example, three levels of intermediate WAN switching (via Local CO, Aggregation CO, and Hub CO). Also, geographically distributed data center switches are located at three levels of DC switching (via Level 3, Level 2 and Level 1). The location of switches in the hierarchy is shown at different levels of the HSDN label structure 50 to illustrate the equivalence between the local CO 14a at Level 3, the aggregation CO 14b at Level 2, and the hub CO 16 at Level 1. In addition, a TOR switch 502 may be located at a user location, acting as a component of an NFV Infrastructure. Note, in this exemplary embodiment, a 4 label stack hierarchy is shown for the HSDN label structure 50.

Two traffic flows 504, 506 illustrate how an HSDN label stack is used to direct packets to different locations in the hierarchy. Between location X (at the local CO 14a) and location Y (at the macro data center 42), four HSDN labels are added to a packet at the source for the traffic flow 506. The packet is sent to the top of its switch hierarchy and then forwarded to the destination Y by popping labels at each switch as it works its way down the macro data center 42 tree. Between location A (at a user premises) and location B (at the aggregation CO 14b), two HSDN labels are added to the packet at a source for the traffic flow 504. The packet is sent to the top of its switch hierarchy (the aggregation CO 14b WAN switch) and then forwarded to the destination B.

### Physical IP Touch/Logical IP Touch

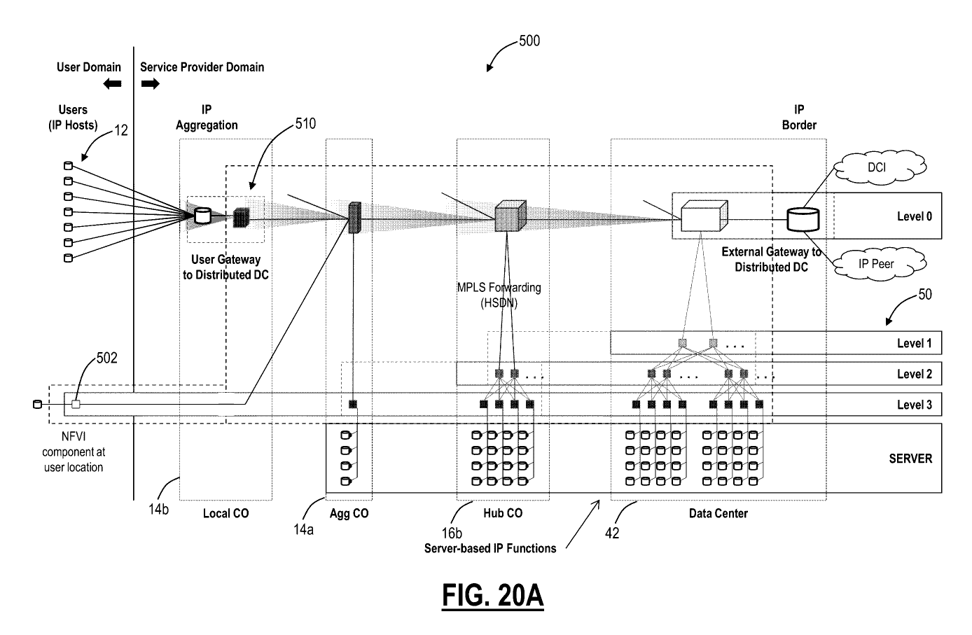

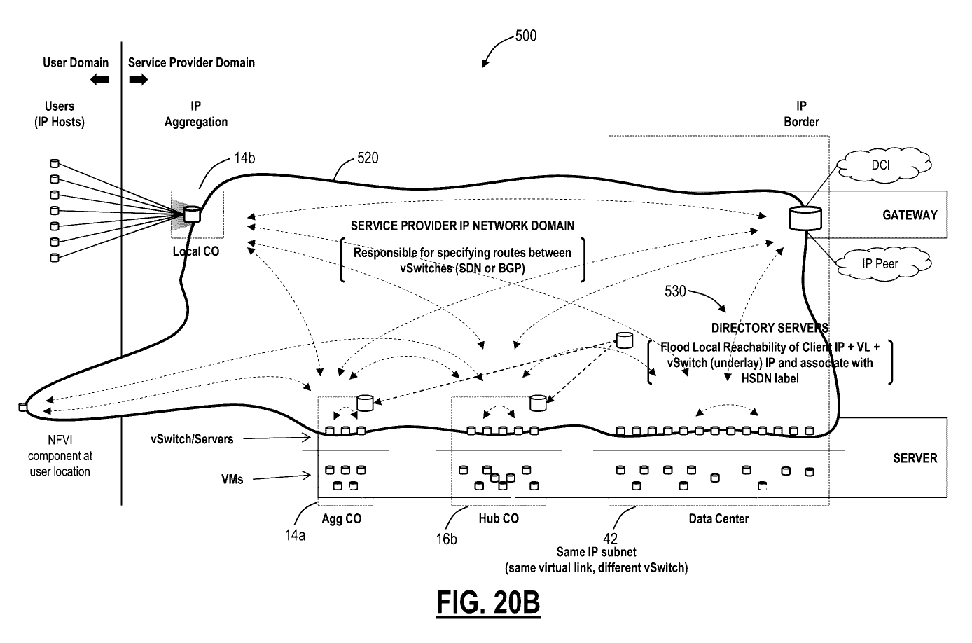

Referring to FIGS. 20A and 20B, in an exemplary embodiment, network diagrams illustrate the network 500 showing the physical locations of IP functions (FIG. 20A) and logical IP connectivity (FIG. 20B). In the distributed data architecture, IP functions are located at the edge of the user-to-content network 10. In the distributed data center architecture, the location of IP processing exists outside the boundary of the data center and data center WAN underlay architecture (the underlay networks 210, 212, 220). User IP traffic flows may be aggregated (dis-aggregated) with an IP aggregation device 510 at the local CO 14a upon entry (exit) to (from) the user-to-content domain. Additionally, any required IP routing and service functions might be virtualized and hosted on virtual machines located on servers in network elements within the WAN 34, in a local CO 14b, aggregation CO 14a, hub CO 16b or in a data center 42. For peering connectivity with other service providers, a border gateway router located at the head-end gateway site might be used.

In FIGS. 20A and 20B, the users 12 and associated IP hosts are outside an IP domain 520 for the service provider, i.e., they do not participate in the routing domain of the service provider. The local CO 14a is the first “IP touch point” in the service provider network. At this location, multiple users' IP flows may be aggregated and forwarded to one or more virtual functions located (e.g. virtual Border Network Gateway (BNG)) within the distributed data center 40. However, a user's Residential Gateway or an Enterprise Customer Premises Equipment (CPE) might be a network element with VNFs that could be part of a data center operator's domain. The local CO 14a is also the first IP touch point in the service provider data center control IP domain 520 and this is where IP flows can be encapsulated in MPLS packets and associated with HSDN labels for connectivity to a destination VM. However, with VNFs in a network element at a user site, the server platform can now add the necessary labels, such as MPLS, to propagate the packet through the distributed data center 40 fabric to reach a destination server. Alternatively, the encapsulations could be such as to be sent to other networks that are not part of the distributed data center 40 fabric.

In the distributed environment where data center addressing is extended, the local CO 14a is the first point where a user's IP flow participates in the service provider routing IP domain 520. Because of this, the data center addressing scheme would supersede the currently provisioned backhaul, for example, because the HSDN has much better scaling properties that today's MPLS approach. In the case of VNFs located in a network element at a user site, the data center addressing scheme would extend to the NFVI component on the server at the user or any other data center site in the WAN 34.

Either the IP aggregation device 510 in the local CO 14a or the server at user site can apply the MPLS label stack going upstream. Going downstream, it removes the final MPLS label (unless Penultimate Hop Popping (PHP) is applied). The IP aggregation device 510 and the edge MPLS device functions may be integrated into the same device. The user hosts connecting to the NFVI do not participate in the service provider data center control IP domain 520, i.e., the data center control IP domain 520 is there only for the operational convenience of the service provider.

To distribute the addresses of VMs across the network, all vSwitches register their IP addresses with a Directory Server 530. There are two planes of addresses, namely the user plane, used by the user and the VM(s) being accessed, and a backbone plane, used by vSwitches and real switches. The Directory Server's 530 job is to flood (probably selectively) the User IPs of the VMs to the User access points and their bindings to the backbone IPs of the vSwitches hosting those VMs. The Directory Server is used to flood addresses to all vSwitches on different server blades. In one implementation, a Master Directory Server 530 is located in the macro data center 42, and Slave Directory Servers are located in micro data centers 44 to achieve scaling efficiency. In another implementation a distributed protocol such as BGP is used to distribute address reachability and label information.

A key point about this distributed data center architecture is that no intermediate IP routing is required in the distributed data center WAN 34 interconnection network. The network uses only MPLS switching with HSDN control. IP routers are not needed because the distributed VMs are all part of a single Clos switch fabric. Also, because all vSwitches/servers are part of same HSDN label space, a tethered server can stack labels to go through the hierarchy to reach destination within remote data center location without needing to pass through a traditional IP Gateway. The common addressing scheme simplifies operation of connecting any pair of virtual machines without complex mappings/de-mapping and without the use of costly IP routing techniques. Further, when using HSDN and Segment Routing (SR) in the same solution, the compatibility between WAN and data center switching technologies simplifies forwarding behavior.

### Asymmetric HSDN Label Stack Across WAN and Distributed Data Center

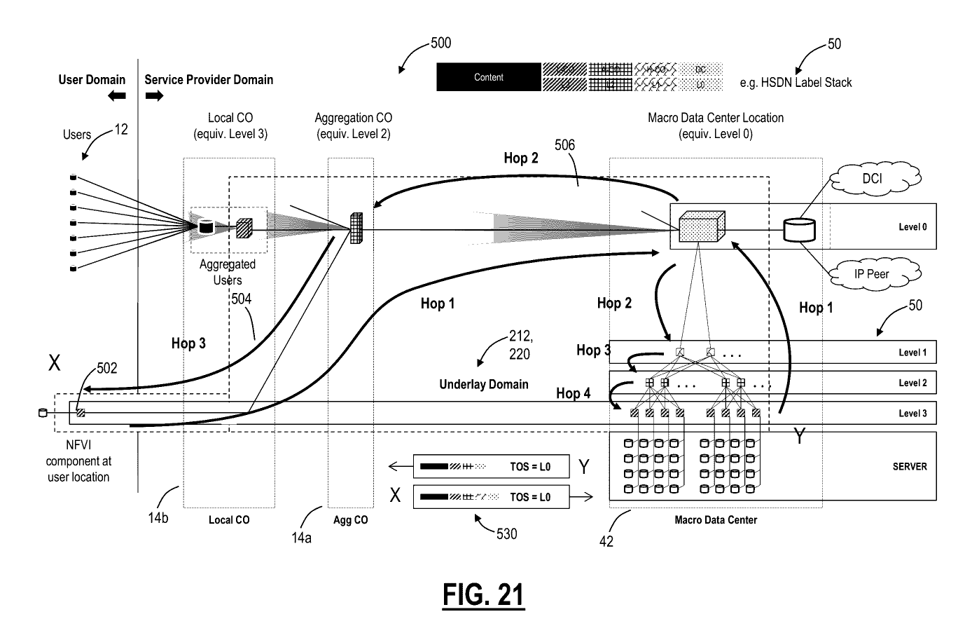

Referring to FIG. 21, in an exemplary embodiment, a network diagram illustrates the network 500 with an asymmetric HSDN label structure 50 that is not matched in opposite directions. FIG. 21 illustrates different label stack depth in opposite directions (4 labels up, 3 labels down). For example, two endpoints are shown in the network 500—location X at a user location and location Y at the macro data center 42. Label stacks 530 are illustrated from the location Y to the location X (uses 3 labels) and from the location X to the location Y (uses 4 labels).

### WAN Extension Network Element(s)

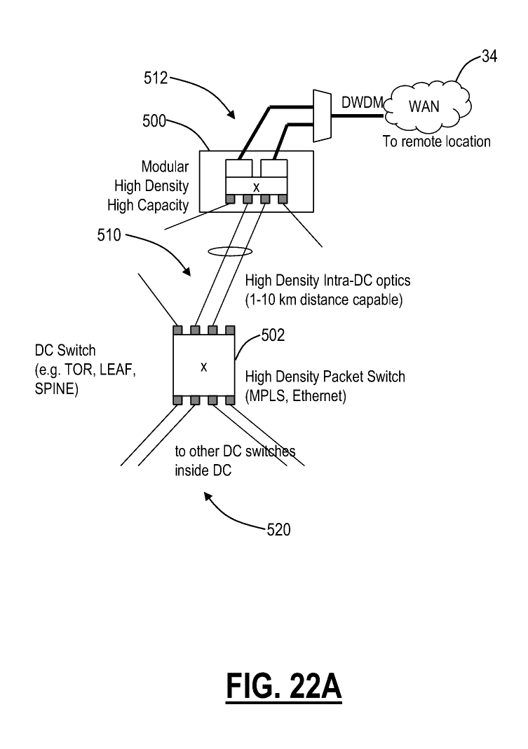

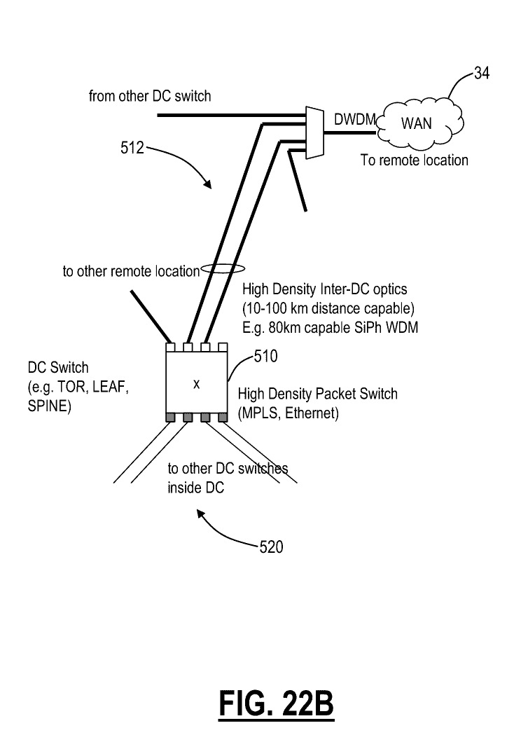

Referring to FIGS. 22A and 22B, in an exemplary embodiment, network diagrams illustrate physical implementations of the WAN GW2 switch at L0 332, WAN GW2 switch at L0 342, and other devices for implementing the distributed data center architecture. FIG. 22A is an exemplary embodiment with separate devices for the media conversion and switching of MPLS packets, namely an optical network element 500 and a switch 502, and FIG. 22B is an exemplary embodiment with integrated high-density WDM optical interfaces directly in a data center switch 510. The network elements in FIGS. 22A and 22B are used to facilitate the distributed data center architecture, acting as an interface between the WAN 34 and the data centers 42, 44. Specifically, the network elements facilitate the underlay networks 210, 212, 220.

Typically, a data center has a gateway to the WAN 34 in order to reach other network regions or public internet access. In this distributed data center architecture, a separate WAN extension solution is used for the specific purpose to enable the interconnection of the physically distributed data center 40 fabric across the WAN 34. Again, two exemplary types of WAN extension are described: the Type 1 WAN extension 82 is used to extend existing north-south data center links across the WAN 34 and the Type 2 WAN extension 84 is used to extend new east-west data center links (i.e., data center shortcuts) across the WAN 34. In each of the above examples, the WAN extension solution serves two purposes. First, it converts internal-facing LAN-scale intra-data center optical signals to external facing WAN-scale inter-data center optical signals. Second, in the direction from a (micro or macro) data center 42, 44 to the WAN 34, it aggregates (fans in) packets from multiple switches into a single WAN connection. In the direction from the WAN 34 to the (micro or macro) data center 42, 44, it receives a traffic aggregate from remote servers and de-aggregates (fans out) the incoming packets towards multiple TOR switches. Implementation options are based on a combination of packet switching and optical transmission technologies.

In FIG. 22A, the physical implementation is provided through the optical network element 500 and the switch 502. The optical network element 500 provides wavelength connectivity to the WAN 34. The optical network element 500 can be a Wavelength Division Multiplexing (WDM) terminal that interfaces with WDM or DWDM to the WAN 34 and any other optical network elements included therein. On a client side 510, the optical network element 500 can provide high-density intra-data center connectivity via short-reach optics to the switch 502 and other devices. On a line side 512, the optical network element 500 provides WDM connections to the WAN 34 which either contain full connections from the switch 502 or aggregated connection from the switch 502 and other devices. For example, the optical network element 500 can provide 2×400 Gbps, 20×40 Gbps, etc. for 800 Gbps per connection. The optical network element 500 can also provide MPLS HSDN aggregation.

The switch 502 can be a data center switch, including a TOR, Leaf, or Spine switch. The switch 502 can be a high-density packet switch providing MPLS, Ethernet, etc. The switch 502 is configured to provide intra-data center connectivity 520, connecting to other data center switches inside the data center as well as well as inter-data center connectivity, connecting to other data center switches in remote data centers over the WAN 34. The switch 502 can be configured to provide the HSDN label structure 50, using a TOS label for the other data center switches in remote data centers over the WAN 34.

FIG. 22B illustrates an exemplary embodiment where the optical network element 500 is removed with integrated DWDM optics on the switch 510. Here, the same functionality is performed as in FIG. 22A, without needing the optical network element 500.

### Use Cases

There are at least five use cases for the distributed data center architecture. A first use case is connecting multiple data centers in a clustered arrangement. As demands grow over time, data center space and power resources will be consumed, and additional resources will need to be added to the data center fabric. In this example, servers in one data center facility communicate with servers in additional data center facilities. A second use case is tethering small markets to larger data center facilities. As demand for distributed application peering grows, a hierarchy of data center facilities will emerge, with smaller data center facilities located in smaller, (e.g. Tier 3 markets) connecting back to larger data center facilities in Tier 2 and Tier 1 markets. In this example, servers in one data center facility communicate with servers in smaller data center facilities.

In other use cases, remote servers may be located outside of traditional data center facilities, either in network central offices, remote cabinets or user premises. A third use case is connecting remote servers located in a central office to larger data center facilities. In this example, computer applications are distributed close to the end users by hosting them on servers located in central offices. The central office may host residential, enterprise or mobile applications in close proximity to other edge switching equipment so as to enable low latency applications. The aggregation function provided by the WAN interface is located in the Central Office. A fourth use case is connecting remote servers located in a remote cabinet to larger data center facilities. In this example, computer applications are distributed close to the end users by hosting them on servers located in remote cabinets. The remote cabinet may be located at locations in close proximity to wireless towers so as to enable ultra-low latency or location dependent mobile edge applications. The aggregation function provided by the WAN interface is located in the Central Office or remote cabinet location. A fifth use case is connecting a user directly (e.g. a large enterprise) to data center facilities. In this example, the WAN interface in the data center provides dedicated connectivity to a single private user's data center. The aggregation function provided by the WAN interface is located in the Central Office, remote cabinet or end user's location.

### Exemplary Packet Switch

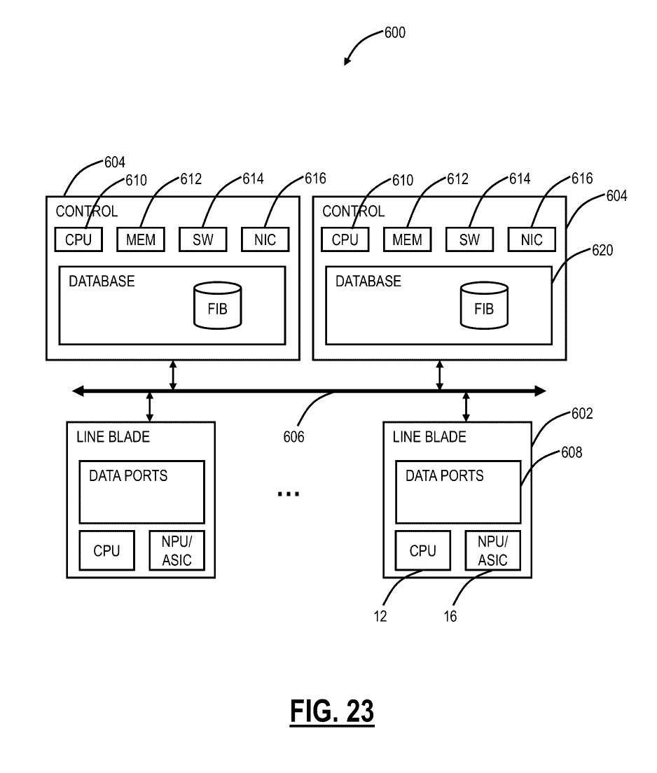

Referring to FIG. 23, in an exemplary embodiment, a block diagram illustrates an exemplary implementation of a switch 600. In this exemplary embodiment, the switch 600 is an Ethernet/MPLS network switch, but those of ordinary skill in the art will recognize the distributed data center architecture described herein contemplate other types of network elements and other implementations. In this exemplary embodiment, the switch 600 includes a plurality of blades 602, 604 interconnected via an interface 606. The blades 602, 604 are also known as line cards, line modules, circuit packs, pluggable modules, etc. and refer generally to components mounted on a chassis, shelf, etc. of a data switching device, i.e., the node 600. Each of the blades 602, 604 can include numerous electronic devices and optical devices mounted on a circuit board along with various interconnects including interfaces to the chassis, shelf, etc.

Two exemplary blades are illustrated with line blades 602 and control blades 604. The line blades 602 include data ports 608 such as a plurality of Ethernet ports. For example, the line blade 602 can include a plurality of physical ports disposed on an exterior of the blade 602 for receiving ingress/egress connections. The physical ports can be short-reach optics (FIG. 22A) or DWDM optics (FIG. 22B). Additionally, the line blades 602 can include switching components to form a switching fabric via the interface 606 between all of the data ports 608 allowing data traffic to be switched between the data ports 608 on the various line blades 602. The switching fabric is a combination of hardware, software, firmware, etc. that moves data coming into the switch 600 out by the correct port 608 to the next node 600, via Ethernet, MPLS, HSDN, SR, etc. “Switching fabric” includes switching units, or individual boxes, in a node; integrated circuits contained in the switching units; and programming that allows switching paths to be controlled. Note, the switching fabric can be distributed on the blades 602, 604, in a separate blade (not shown), or a combination thereof. The line blades 602 can include an Ethernet manager (i.e., a CPU) and a network processor (NP)/application specific integrated circuit (ASIC). As described herein, the line blades 602 can enable the distributed data center architecture using the HSDN, SR, and other techniques described herein.

The control blades 604 include a microprocessor 610, memory 612, software 614, and a network interface 616. Specifically, the microprocessor 610, the memory 612, and the software 614 can collectively control, configure, provision, monitor, etc. the switch 600. The network interface 616 may be utilized to communicate with an element manager, a network management system, etc. Additionally, the control blades 604 can include a database 620 that tracks and maintains provisioning, configuration, operational data and the like. The database 620 can include a forwarding information base (FIB) that may be populated as described herein (e.g., via the user triggered approach or the asynchronous approach). In this exemplary embodiment, the switch 600 includes two control blades 604 which may operate in a redundant or protected configuration such as 1:1, 1+1, etc. In general, the control blades 604 maintain dynamic system information including Layer two forwarding databases, protocol state machines, and the operational status of the ports 608 within the switch 600.

### Exemplary Optical Network Element/DWDM Capable Switch

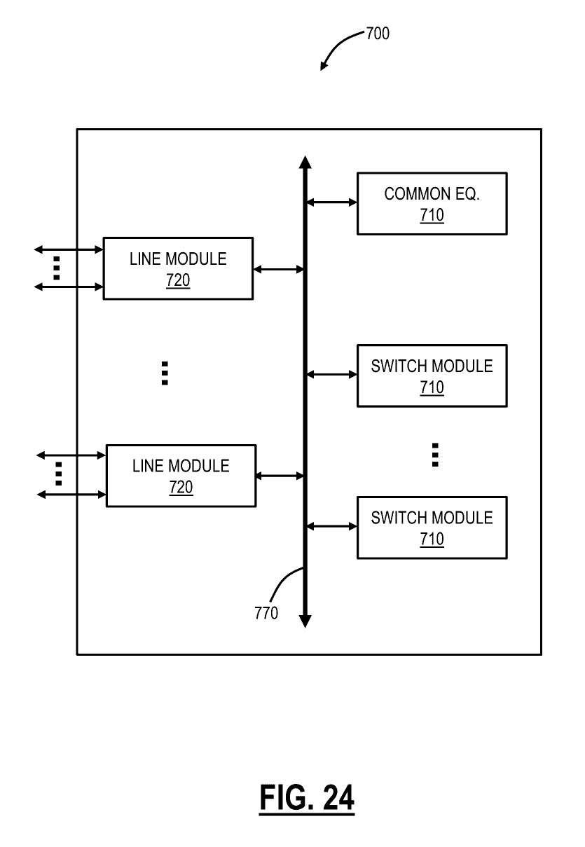

Referring to FIG. 24, in an exemplary embodiment, a block diagram illustrates an exemplary implementation of a network element 700. For example, the switch 600 can be a dedicated Ethernet switch whereas the network element 700 can be a multiservice platform. In an exemplary embodiment, the network element 700 can be a nodal device that may consolidate the functionality of a multi-service provisioning platform (MSPP), digital cross connect (DCS), Ethernet and Optical Transport Network (OTN) switch, dense wave division multiplexed (DWDM) platform, etc. into a single, high-capacity intelligent switching system providing Layer 0, 1, and 2 consolidation. In another exemplary embodiment, the network element 700 can be any of an OTN add/drop multiplexer (ADM), a SONET/SDH ADM, a multi-service provisioning platform (MSPP), a digital cross-connect (DCS), an optical cross-connect, an optical switch, a router, a switch, a WDM terminal, an access/aggregation device, etc. That is, the network element 700 can be any system with ingress and egress signals and switching of channels, timeslots, tributary units, wavelengths, etc. While the network element 700 is shown as an optical network element, the systems and methods are contemplated for use with any switching fabric, network element, or network based thereon.

In an exemplary embodiment, the network element 700 includes common equipment 710, one or more line modules 720, and one or more switch modules 730. The common equipment 710 can include power; a control module; operations, administration, maintenance, and provisioning (OAM&P) access; and the like. The common equipment 710 can connect to a management system such as a network management system (NMS), element management system (EMS), or the like. The network element 700 can include an interface 770 for communicatively coupling the common equipment 710, the line modules 720, and the switch modules 730 together. For example, the interface 770 can be a backplane, mid-plane, a bus, optical or electrical connectors, or the like. The line modules 720 are configured to provide ingress and egress to the switch modules 730 and external to the network element 700. In an exemplary embodiment, the line modules 720 can form ingress and egress switches with the switch modules 730 as center stage switches for a three-stage switch, e.g., a three-stage Clos switch. The line modules 720 can include optical or electrical transceivers, such as, for example, 1 Gb/s (GbE PHY), 2.5 Gb/s (OC-48/STM-1, OTU1, ODU1), 10 Gb/s (OC-192/STM-64, OTU2, ODU2, 10 GbE PHY), 40 Gb/s (OC-768/STM-256, OTU3, ODU3, 40 GbE PHY), 100 Gb/s (OTU4, ODU4, 100 GbE PHY), ODUflex, 100 Gb/s+(OTUCn), etc.

Further, the line modules 720 can include a plurality of connections per module and each module may include a flexible rate support for any type of connection, such as, for example, 155 Mb/s, 622 Mb/s, 1 Gb/s, 2.5 Gb/s, 10 Gb/s, 40 Gb/s, and 100 Gb/s. The line modules 720 can include wavelength division multiplexing interfaces, short reach interfaces, and the like, and can connect to other line modules 720 on remote network elements, end clients, edge routers, and the like. From a logical perspective, the line modules 720 provide ingress and egress ports to the network element 700, and each line module 720 can include one or more physical ports. The switch modules 730 are configured to switch channels, timeslots, tributary units, wavelengths, etc. between the line modules 720. For example, the switch modules 730 can provide wavelength granularity (Layer 0 switching); OTN granularity such as Optical Channel Data Unit-1 (ODU1), Optical Channel Data Unit-2 (ODU2), Optical Channel Data Unit-3 (ODU3), Optical Channel Data Unit-4 (ODU4), Optical Channel Data Unit-flex (ODUflex), Optical channel Payload Virtual Containers (OPVCs), etc.; packet granularity; and the like. Specifically, the switch modules 730 can include both Time Division Multiplexed (TDM) (i.e., circuit switching) and packet switching engines. The switch modules 730 can include redundancy as well, such as 1:1, 1:N, etc.

Those of ordinary skill in the art will recognize the switch 600 and the network element 700 can include other components that are omitted for illustration purposes, and that the systems and methods described herein are contemplated for use with a plurality of different nodes with the switch 600 and the network element 700 presented as an exemplary type of node. For example, in another exemplary embodiment, a node may not include the switch modules 730, but rather have the corresponding functionality in the line modules 720 (or some equivalent) in a distributed fashion. For the switch 600 and the network element 700, other architectures providing ingress, egress, and switching are also contemplated for the systems and methods described herein. In general, the systems and methods described herein contemplate use with any node providing switching or forwarding of channels, timeslots, tributary units, wavelengths, etc.

In an exemplary embodiment, a network element, such as the switch 600, the optical network element 700, etc., is configured to provide a distributed data center architecture between at least two data centers. The network element includes a plurality of ports configured to switch packets between one another; wherein a first port of the plurality of ports is connected to an intra-data center network of a first data center and a second port of the plurality of ports is connected to a second data center remote from the first data center over a Wide Area Network (WAN), and wherein the intra-data center network, the WAN, and an intra-data center network of the second data center utilize an ordered label structure between one another to form the distributed data center architecture. The ordered label structure can include a unified label space between the intra-data center network, the WAN, and the intra-data center network of the second data center. The ordered label structure can include a unified label space between the intra-data center network and the intra-data center network of the second data center, and tunnels in the WAN connecting the intra-data center network and the intra-data center network of the second data center. The distributed data center architecture only uses Multiprotocol Label Switching (MPLS) in the WAN 34 with Internet Protocol (IP) routing at edges of the distributed data center architecture. The ordered label structure can utilize Multiprotocol Label Switching (MPLS) with Hierarchical Software Defined Networking (HSDN) control.

Optionally, the ordered label structure can include a rigid switch hierarchy between the intra-data center network, the WAN, and the intra-data center network of the second data center. Alternatively, the ordered label structure can include an unmatched switch hierarchy between the intra-data center network, the WAN, and the intra-data center network of the second data center. The network element can further include a packet switch communicatively coupled to the plurality of ports and configured to perform Multiprotocol Label Switching (MPLS) per Hierarchical Software Defined Networking (HSDN) control using the ordered label structure; and a media adapter function configured to create a Wavelength Division Multiplexing (WDM) signal for the second port over the WAN. A first device in the first data center can be configured to communicate with a second device in the second data center using the ordered label structure to perform Multiprotocol Label Switching (MPLS) per Hierarchical Software Defined Networking (HSDN) control using the ordered label structure, without using Internet Protocol (IP) routing between the first device and the second device.

In another exemplary embodiment, a method performed by a network element to provide a distributed data center architecture between at least two data centers includes receiving a packet on a first port connected to an intra-data center network of a first data center, wherein the packet is destined for a device in an intra-data center network of a second data center, wherein the first data center and the second data center are geographically diverse and connected over a Wide Area Network (WAN) in the distributed data center architecture; and transmitting the packet on a second port connected to the WAN with a label stack thereon using a ordered label structure to reach the device in the second data center. The ordered label structure can utilize Multiprotocol Label Switching (MPLS) with Hierarchical Software Defined Networking (HSDN) control.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A network element configured to provide a single distributed data center architecture between at least two data center locations, the network element comprising:
a plurality of ports configured to switch packets between one another;
wherein a first port of the plurality of ports is connected to an intra-data center network of a first data center location and a second port of the plurality of ports is connected to a second data center location that is remote from the first data center location over a Wide Area Network (WAN), and
wherein the intra-data center network of the first data center location, the WAN, and an intra-data center network of the second data center location utilize a ordered label structure between one another to form the single distributed data center architecture.

2. The network element of claim 1, wherein the ordered label structure is a unified label space between the intra-data center network of the first data center location, the WAN, and the intra-data center network of at least the second data center location.

3. The network element of claim 1, wherein the ordered label structure is a unified label space between the intra-data center network of the first data center location and the intra-data center network of the second data center location, and tunnels in the WAN connecting the intra-data center network of the first data center location and the intra-data center network of at least the second data center location.

4. The network element of claim 1, wherein the distributed data center architecture only uses Multiprotocol Label Switching (MPLS) in the intra geographically distributed data center WAN with Internet Protocol (IP) routing at edges of the distributed data center architecture.

5. The network element of claim 1, wherein the ordered label structure utilizes Multiprotocol Label Switching (MPLS) with Hierarchical Software Defined Networking (HSDN).

6. The network element of claim 5, wherein the ordered label structure further utilizes Segment Routing in an underlay network in the WAN.

7. The network element of claim 1, wherein the ordered label structure is a rigid switch hierarchy between the intra-data center network of the first data center location, the WAN, and the intra-data center network of at least the second data center location.

8. The network element of claim 1, wherein the ordered label structure is an unmatched switch hierarchy between the intra-data center network of the first data center location, the WAN, and at least the intra-data center network of the second data center location.

9. The network element of claim 1, wherein the ordered label structure is a matched switch hierarchy with logically matched waypoints between the intra-data center network of the first data center location, the WAN, and at least the intra-data center network of the second data center location.

10. The network element of claim 1, further comprising:
a packet switch communicatively coupled to the plurality of ports and configured to perform Multiprotocol Label Switching (MPLS) per Hierarchical Software Defined Networking (HSDN) using the ordered label structure; and
a media adapter function configured to create a Wavelength Division Multiplexing (WDM) signal for the second port over the WAN.

11. The network element of claim 1, wherein a first device in the first data center location is configured to communicate with a second device in the second data center location using the ordered label structure to perform Multiprotocol Label Switching (MPLS) per Hierarchical Software Defined Networking (HSDN), without using Internet Protocol (IP) routing between the first device and the second device.

12. An underlay network formed by one or more network elements and configured to provide a geographically distributed data center architecture between at least two data center locations, the underlay network comprising:
a first plurality of network elements communicatively coupled to one another forming a data center underlay; and
a second plurality of network elements communicatively coupled to one another forming a Wide Area Network (WAN) underlay, wherein at least one network element of the first plurality of network elements is connected to at least one network element of the second plurality of network elements,
wherein the data center underlay and the WAN underlay utilize a ordered label structure between one another to define paths through the distributed data center architecture.

13. The underlay network of claim 12, wherein the ordered label structure comprises a unified label space between the data center underlay and the WAN underlay, such that the data center underlay and the WAN underlay form a unified label domain under a single administration.

14. The underlay network of claim 12, wherein the ordered label structure comprises a unified label space between the at least two data center locations connected by the data center underlay, and tunnels in the WAN underlay connecting the at least two data center locations, such that the data center underlay and the WAN underlay form separately-administered label domains.

15. The underlay network of claim 12, wherein the distributed data center architecture only uses Multiprotocol Label Switching (MPLS) in the WAN with Internet Protocol (IP) routing at edges of a label domain for the distributed data center architecture.

16. The underlay network of claim 12, wherein the ordered label structure utilizes Multiprotocol Label Switching (MPLS) with Hierarchical Software Defined Networking (HSDN).

17. The underlay network of claim 12, wherein the ordered label structure is a rigid switch hierarchy between the data center underlay and the WAN underlay.

18. The underlay network of claim 12, wherein the ordered label structure is an unmatched switch hierarchy between the data center underlay and the WAN underlay.

19. The underlay network of claim 12, wherein at least one of the network elements in the first plurality of network elements and the second plurality of network elements comprises
a packet switch communicatively coupled to a plurality of ports and configured to perform Multiprotocol Label Switching (MPLS) per Hierarchical Software Defined Networking (HSDN) using the ordered label structure, and
a media adapter function configured to create a Wavelength Division Multiplexing (WDM) signal for a second port over the WAN.

20. A method performed by a network element to provide a distributed data center architecture between at least two data centers, the method comprising:
receiving a packet on a first port connected to an intra-data center network of a first data center, wherein the packet is destined for a device in an intra-data center network of a second data center, wherein the first data center and the second data center are geographically diverse and connected over a Wide Area Network (WAN) in the distributed data center architecture; and
transmitting the packet on a second port connected to the WAN with a label stack thereon using a ordered label structure to reach the device in the second data center.
